(19) United States
(12) Patent Application Publication
(10) Pub. No.: US 2016/0100355 A1
(43) Pub. Date: Apr. 7, 2016

(54) METHOD AND DEVICE FOR PROCESSING D2D MEASUREMENT

(71) Applicant: ZTE CORPORATION, Guangdong (CN)

(72) Inventors: Lin CHEN, Shenzhen (CN); Ying HUANG, Shenzhen (CN); Feng XIE, Shenzhen (CN)

(21) Appl. No.: 14/889,205

(22) PCT Filed: May 4, 2014
(86) PCT No.: PCT/CN2014/076731

§ 371 Date: Nov. 5, 2015

(30) Foreign Application Priority Data
May 8, 2013 (CN) 201310167198.8

(51) Int. Cl. H04W 48/16; H04W 72/08; H04W 72/04; H04W 76/04; H04W 76/06; H04W 72/12; H04W 52/02

(52) U.S. Cl. CPC H04W 48/16; H04W 72/1215; H04W 72/085; H04W 52/0209; H04W 76/046; H04W 76/068; H04W 72/048; H04W 88/06

(57) ABSTRACT

Provided are a method and device for processing a D2D measurement. The method includes: D2D measurement configuration information transmitted by a network node is received, wherein the D2D measurement configuration information is UE-based D2D measurement configuration information; UE-based D2D measurement is performed according to the D2D measurement configuration information; and a D2D measurement result obtained by measurement is reported according to the D2D measurement configuration information. By the disclosure, the problem of incapability in effectively controlling D2D discovery and D2D communication in the related art is solved, and effects of effectively controlling D2D discovery and D2D communication, increasing a resource utilization rate and improving quality of user service are further achieved.

### TECHNICAL FIELD

The disclosure relates to the field of communication, and in particular to a method and device for processing a Device-to-Device (D2D) measurement.

### BACKGROUND

Along with development of wireless multimedia services, requirements of people on high data rate and user experiences increasingly grow, so that higher requirements on system capacity and coverage of a conventional cellular network are proposed. On the other hand, requirements of people on knowing about interested persons or things nearby and proximity service on these persons or things gradually increase along with prevailing of applications such as a social network, short-distance data sharing and local advertising. A conventional cell-based cellular network brings obvious limitations in terms of support to high data rate and proximity service, and in such a requirement background, a D2D technology representative of a new direction of future development of communication technologies emerges. Application of a D2D technology may reduce a burden of a cellular network, reduce battery power consumption of User Equipment (UE), increase data rate, improve robustness of a network infrastructure and well meet requirements on a high-data rate service and proximity service.

A D2D technology may work in an authorized frequency band or an unauthorized frequency band, and allows direct discovery/direct communication between multiple UEs supporting a D2D function with a network infrastructure or without a network infrastructure. FIG. 1 is a diagram of D2D communication in a related art. As shown in FIG. 1, there are mainly three D2D application scenarios as follows: (1) UE1 and UE2 perform data interaction under coverage of a cellular network, and user plane data does not pass through a network infrastructure, as shown in mode 1 in FIG. 1; (2) UE in a weakly-covered/uncovered area performs relay transmission, as shown in mode 2 in FIG. 1, and UE4 with poorer signal quality is allowed to communicate with the network through UE3 covered by the network nearby, which may help an operator to extend the coverage and improve capacity; and (3) direct communication among equipment is allowed under the condition that the cellular network may not work normally in case of an earthquake or emergency, as shown in mode 3 in FIG. 1, and a control plane and a user plane among UE5, UE6 and UE7 may perform one-hop or multi-hop data communication without any network infrastructure.

A D2D technology usually includes a D2D discovery technology and a D2D communication technology: (1) the D2D discovery technology refers to a technology configured to judge/determine that two or more D2D UEs are proximal each other (for example, within a range where D2D direct communication is allowed) or configured to judge/determine that first UE is proximal to second UE; and (2) the D2D communication technology refers to a technology configured to realize direct communication of a part or all of communication data between D2D UE without a network infrastructure.

In a scenario with a cellular network coverage, an operator network is required to participate in and assist D2D discovery and communication processes to realize management and control the D2D discovery and D2D communication. For example, the network is required to acquire a condition, detected by D2D UE, of adjacent UE so as to determine whether establishment of a D2D connection or D2D communication is allowed or not. While in an existing cellular communication system, UE only correspondingly measures its residing cell or serving cell and an adjacent cell and reports a measurement result to a cellular network, which may cause an incapability of the operator network in managing and controlling the D2D discovery and communication processes of the D2D UE.

Therefore, there exists the problem of incapability in effectively controlling D2D discovery and D2D communication in the related art.

### SUMMARY

A method and device for processing a D2D measurement is provided, so as to at least solve the problem of incapability in effectively controlling D2D discovery and D2D communication in the related art.

According to one aspect of the disclosure, a method for processing a Device-to-Device (D2D) measurement is provided, comprising: receiving D2D measurement configuration information issued by a network node, wherein the D2D measurement configuration information is User Equipment (UE)-based D2D measurement configuration information; performing a UE-based D2D measurement according to the D2D measurement configuration information; and reporting, according to the D2D measurement configuration information, a D2D measurement result obtained by the UE-based D2D measurement.

In an example embodiment, the D2D measurement configuration information comprises at least one of: UE-based measurement object information, a UE-based measurement reporting condition and a UE-based measurement reporting content. In an example embodiment, performing the UE-based D2D measurement according to the D2D measurement configuration information comprises at least one of: performing, by a UE in a Radio Resource Control (RRC) idle state, the UE-based D2D measurement according to the D2D measurement configuration information which is obtained by the UE when the UE is in an RRC idle state; performing, by a UE in an RRC idle state, the UE-based D2D measurement according to the D2D measurement configuration information which is obtained by the UE when the UE is in an RRC connected state; performing, by a UE in an RRC connected state, the UE-based D2D measurement according to the D2D measurement configuration information which is obtained by the UE when the UE is in an RRC idle state; and performing, by a UE in an RRC connected state, the UE-based D2D measurement according to the D2D measurement configuration information which is obtained by the UE when the UE is in an RRC connected state.

In an example embodiment, performing the UE-based D2D measurement according to the D2D measurement configuration information comprises at least one of: when the UE-based measurement object information comprised in the D2D measurement configuration information comprises an indicated resource, which comprises at least one of: a time-domain resource, a frequency-domain resource and a code-domain resource, performing a D2D measurement on a UE using the indicated resource; when the UE-based measurement object information in the D2D measurement configuration information comprises identification information used for indicating a measurement object, performing a D2D measurement on a UE identified by the identification information or a UE used by a user identified by the identification information; when the UE-based measurement object information comprised in the D2D measurement configuration information comprises a indicated measurement range, performing a D2D measurement on a UE within the indicated measurement range; and when the UE-based measurement object information comprised in the D2D measurement configuration information comprises an indicated measurement D2D group, performing a D2D measurement on a UE in the indicated measurement D2D group.

In an example embodiment, performing the UE-based D2D measurement according to the D2D measurement configuration information comprises: performing the D2D measurement on the UE by measuring a D2D signal sent by the UE.

In an example embodiment, the D2D signal comprises at least one of: a discovery signal, a reference signal, a synchronization signal, a pilot frequency signal and a preamble signal.

In an example embodiment, the identification information comprises at least one of: UE identification information of a friend in an application program of the UE, user identification information of a friend in the application program of the UE, UE identification information of a UE currently performing cellular network communication with the UE and user identification information of a user currently performing cellular network communication with the UE.

In an example embodiment, the indicated measurement range comprises at least one of: a geographical location range, a signal strength range and a signal quality range.

In an example embodiment, reporting, according to the UE-based measurement reporting condition, the D2D measurement result obtained by the UE-based D2D measurement comprises at least one of: when the UE-based measurement reporting condition comprised in the D2D measurement configuration information is a event-based triggering condition, judging whether the D2D measurement result meets a reporting triggering threshold condition comprised in the UE-based measurement reporting condition or not, and when a judgment result is that the D2D measurement result meets the reporting triggering threshold condition comprised in the UE-based measurement reporting condition, reporting the D2D measurement result; when the UE-based measurement reporting condition comprised in the D2D measurement configuration information is a periodic triggering condition, reporting the D2D measurement result according to a period indicated in the UE-based measurement reporting condition; when the UE-based measurement reporting condition comprised in the D2D measurement configuration information is a event-based periodic triggering condition, reporting the D2D measurement result according to a threshold value condition and a period comprised in the UE-based measurement reporting condition; and when the UE-based measurement reporting condition comprised in the D2D measurement configuration information is a condition of reporting the D2D measurement result at the same time of sending a cellular system measurement report, reporting the D2D measurement result at the same time when the cellular system measurement report is sent.

In an example embodiment, reporting the D2D measurement result at the same time when the cellular system measurement report is sent comprises at least one of: triggering reporting of the D2D measurement result at the same time when the cellular system measurement report is triggered; and containing the D2D measurement result in the cellular system measurement report.

In an example embodiment, the D2D measurement result reported according to the UE-based measurement reporting content comprises at least one of: identification information of a UE sending a D2D signal received by a current UE; a D2D signal resource used by a D2D signal received by a current UE; signal strength of a D2D signal received by a current UE; signal quality of a D2D signal received by a current UE; indication information indicating whether a current UE is currently performing cellular communication with a UE sending a D2D signal received by the current UE or not; identification information of a UE currently performing D2D communication with a current UE; indication information about whether a current UE tends to adopt D2D communication or not; and D2D capability information of a current UE.

In an example embodiment, the identification information of the UE sending the D2D signal received by the current UE comprises at least one of: UE identification information for identifying the UE sending the D2D signal; user identification information for identifying a user using the UE sending the D2D signal; D2D group identification information for identifying a D2D group to which the UE sending the D2D signal belongs; and D2D group identification information for identifying a D2D group to which the user of the UE sending the D2D signal belongs.

In an example embodiment, after receiving the D2D measurement configuration information issued by the network node, wherein the D2D measurement configuration information is UE-based D2D measurement configuration information, further comprising: when a residing cell is replaced, deleting a measurement configuration indicated by the D2D measurement configuration information received, by a UE in an RRC idle state, in an original residing cell; or, when deletion indication information carried in the D2D measurement configuration information issued by the network node is received, deleting a measurement configuration corresponding to the deletion indication information, wherein the deletion indication information is received by a UE in an RRC connected state.

According to another aspect of the present disclosure, a method for processing a Device-to-Device (D2D) measurement is provided, comprising: sending D2D measurement configuration information to a User Equipment (UE), wherein the D2D measurement configuration information is UE-based D2D measurement configuration information; and receiving a D2D measurement result reported by the UE according to the D2D measurement configuration information, wherein the UE performs a UE-based D2D measurement according to the D2D measurement configuration information.

In an example embodiment, wherein the D2D measurement configuration information comprises at least one of: UE-based measurement object information, a UE-based measurement reporting condition and a UE-based measurement reporting content.

In an example embodiment, before sending the D2D measurement configuration information to the UE, wherein the D2D measurement configuration information is UE-based D2D measurement configuration information, further comprising: determining location information of the UE in a cell; and configuring the D2D measurement configuration information for the UE according to the location information of the UE in the cell.

In an example embodiment, before sending the D2D measurement configuration information to the UE, wherein the D2D measurement configuration information is UE-based D2D measurement configuration information, further comprising at least one of: configuring the D2D measurement configuration information for the UE according to information received from a D2D server; configuring the D2D measurement configuration information for the UE according to a network burden reduction requirement; configuring the D2D measurement configuration information for the UE according to a power-saving requirement of the UE; and

configuring the D2D measurement configuration information for the UE according to a Quality of Service (QoS) requirement of the UE.

In an example embodiment, the D2D measurement configuration information is sent to the UE in a system broadcasting manner and/or in a dedicated signalling manner.

In an example embodiment, sending the D2D measurement configuration information to the UE in the system broadcasting manner comprises: broadcasting at least one of the following information in the system broadcasting manner: a time-domain resource available for the UE in a cell of a network node, a frequency-domain resource available for the UE in the cell of the network node, a code-domain resource available for the UE in the cell of the network node and identification information available for the UE in the cell of the network node.

In an example embodiment, after receiving the D2D measurement result reported by the UE according to the D2D measurement configuration information, further comprising at least one of: performing a D2D discovery operation according to the D2D measurement result; performing a D2D communication operation according to the D2D measurement result; judging whether to initiate a D2D connection establishment process for the UE or not according to the D2D measurement result, and when a judgement result is to initiate the D2D connection establishment process for the UE, initiating the D2D connection establishment process; judging whether to convert a communication manner of the UE from cellular communication into D2D communication or not according to the D2D measurement result, and when a judgement result is to convert the communication manner of the UE from the cellular communication into the D2D communication, converting the communication manner of the UE from the cellular communication into the D2D communication; and judging whether to convert the communication manner of the UE from the D2D communication into the cellular communication or not according to the D2D measurement result, and when a judgment result is to convert the communication manner of the UE from the D2D communication into the cellular communication, converting the communication manner of the UE from the D2D communication into the cellular communication.

According to one aspect of the present disclosure, a device for processing a Device-to-Device (D2D) measurement is provided, comprising: a first receiving component, configured to receive D2D measurement configuration information issued by a network node, wherein the D2D measurement configuration information is based on a User Equipment (UE); a first measuring component, configured to perform a UE-based D2D measurement according to the D2D measurement configuration information; and a first reporting component, configured to report, according to the D2D measurement configuration information, a D2D measurement result obtained by the UE-based D2D measurement.

In an example embodiment, the first measuring component comprises at least one of: a first measuring element, configured for a UE in a Radio Resource Control (RRC) idle state to perform the UE-based D2D measurement according to the D2D measurement configuration information which is obtained by the UE when the UE is in an RRC idle state; a second measuring element, configured for the UE in an RRC idle state to perform the UE-based D2D measurement according to the D2D measurement configuration information which is obtained by the UE when the UE is in an RRC connected state; a third measuring element, configured for the UE in an RRC connected state to perform the UE-based D2D measurement according to the D2D measurement configuration information which is obtained by the UE when the UE is in an RRC idle state; and a fourth measuring element, configured for the UE in an RRC connected state to perform the UE-based D2D measurement according to the D2D measurement configuration information which is obtained by the UE when the UE is in an RRC connected state.

In an example embodiment, the first measuring component comprises at least one of: a fifth measuring element, configured to, when the UE-based measurement object information comprised in the D2D measurement configuration information comprises an indicated resource, which comprises at least one of: a time-domain resource, a frequency-domain resource and a code-domain resource, perform a D2D measurement on a UE using the indicated resource; a sixth measuring element, configured to, when the UE-based measurement object information comprised in the D2D measurement configuration information comprises identification information used for identifying a measurement object, perform a D2D measurement on a UE identified by the identification information or a UE used by a user identified by the identification information; a seventh measuring element, configured to, when the UE-based measurement object information comprised in the D2D measurement configuration information comprises a indicated measurement range, perform a D2D measurement on a UE within the indicated measurement range; and an eighth measuring element, configured to, when the UE-based measurement object information comprised in the D2D measurement configuration information comprises an indicated measurement D2D group, perform a D2D measurement on a UE in the indicated measurement D2D group.

In an example embodiment, the first measuring component is further configured to perform a D2D measurement on the UE by measuring a D2D signal sent by the UE.

In an example embodiment, the first reporting component comprises at least one of: a first reporting element, configured to, when the UE-based measurement reporting condition comprised in the D2D measurement configuration information is a event-based triggering condition, judge whether the D2D measurement result meets a reporting triggering threshold condition comprised in the UE-based measurement reporting condition or not, and when a judgment result is that the D2D measurement result meets the reporting triggering threshold condition comprised in the UE-based measurement reporting condition, report the D2D measurement result; a second reporting element, configured to, when the UE-based measurement reporting condition comprised in the D2D measurement configuration information is a periodic triggering condition, report the D2D measurement result according to a period indicated in the UE-based measurement reporting condition; a third reporting element, configured to, when the UE-based measurement reporting condition comprised in the D2D measurement configuration information is a event-based periodic triggering condition, report the D2D measurement result according to a threshold value condition and a period comprised in the UE-based measurement reporting condition; and a fourth reporting element, configured to, when the UE-based measurement reporting condition comprised in the D2D measurement configuration information is a condition of reporting the D2D measurement result at the same time of sending a cellular system measurement report, report the D2D measurement result at the same time when the cellular system measurement report is given.

In an example embodiment, the device further comprises: a first deleting component, configured to, when a residing cell is replaced, delete a measurement configuration indicated by the D2D measurement configuration information received, by a UE in an RRC idle state, in an original residing cell; or, a second deleting component, configured to, when deletion indication information carried in the D2D measurement configuration information issued by the network node is received, delete a measurement configuration corresponding to the deletion indication information, wherein the deletion indication information is received by a UE in an RRC connected state.

According to another aspect of the present disclosure, a device for processing a Device-to-Device (D2D) measurement is provided, comprising: a first sending component, configured to send D2D measurement configuration information to a User Equipment (UE), wherein the D2D measurement configuration information is based on the UE; and a second receiving component, configured to receive a D2D measurement result reported by the UE according to the D2D measurement configuration information, wherein the UE performs a UE-based D2D measurement according to the D2D measurement configuration information.

In an example embodiment, the device further comprises: a first determining component, configured to determine location information of the UE in a cell; and a first configuring component, configured to configure the D2D measurement configuration information for the UE according to the location information of the UE in the cell.

In an example embodiment, the device further comprises at least one of: a second configuring component, configured to configure the D2D measurement configuration information for the UE according to information received from a D2D server; a third configuring component, configured to configure the D2D measurement configuration information to the UE according to a network burden reduction requirement; a fourth configuring component, configured to configure the D2D measurement configuration information for the UE according to a power-saving requirement of the UE; and a fifth configuring component, configured to configure the D2D measurement configuration information for the UE according to a Quality of Service (QoS) requirement of the UE.

In an example embodiment, the device further comprises at least one of: a first performing component, configured to perform a D2D discovery operation according to the D2D measurement result; a second performing component, configured to perform a D2D communication operation according to the D2D measurement result; a first judging component, configured to judge whether to initiate a D2D connection establishment process for the UE or not according to the D2D measurement result, and when a judgement result is to initiate the D2D connection establishment process for the UE, initiate the D2D connection establishment process; a second judging component, configured to judge whether to convert a communication manner of the UE from cellular communication into D2D communication or not according to the D2D measurement result, and when a judgement result is to convert the communication manner of the UE from the cellular communication into the D2D communication, convert the communication manner of the UE from the cellular communication into the D2D communication; and a third judging component, configured to judge whether to convert the communication manner of the UE from the D2D communication into the cellular communication or not according to the D2D measurement result, and when a judgment result is to convert the communication manner of the UE from the D2D communication into the cellular communication, convert the communication manner of the UE from the D2D communication into the cellular communication.

By the disclosure, the D2D measurement configuration information based on the UE which is issued by the network node is received; the UE-based D2D measurement is performed according to the D2D measurement configuration information; and the D2D measurement result obtained by the UE-based D2D measurement is reported according to the D2D measurement configuration information, so that the problem of incapability in effectively controlling D2D discovery and D2D communication in the related art is solved, and effects of effectively controlling D2D discovery and D2D communication, increasing a resource utilization rate and improving quality of user service are further achieved.

### BRIEF DESCRIPTION OF THE DRAWINGS

The drawings described here are adopted to provide further understanding of the disclosure, and form a part of the disclosure. Schematic embodiments of the disclosure and description thereof are adopted to explain the disclosure and not intended to form improper limits to the disclosure. In the drawings:

FIG. 1 is a diagram of D2D communication in a related technology;

FIG. 2 is a first flowchart of the method for processing the D2D measurement according to the embodiment of the disclosure;

FIG. 3 is a second flowchart of the method for processing the D2D measurement according to an embodiment of the disclosure;

FIG. 4 is a structure diagram of a first device for processing a D2D measurement according to an embodiment of the disclosure;

FIG. 5 is a first example structure diagram of the first measuring component 44 in the first device for processing the D2D measurement according to an embodiment of the disclosure;

FIG. 6 is a second example structure diagram of the first measuring component 44 in the first device for processing the D2D measurement according to an embodiment of the disclosure;

FIG. 7 is an example structure diagram of the first reporting component 46 in the first device for processing the D2D measurement according to an embodiment of the disclosure;

FIG. 8 is an example structure diagram of the first device for processing the D2D measurement according to an embodiment of the disclosure;

FIG. 9 is a structure diagram of a second device for processing a D2D measurement according to an embodiment of the disclosure;

FIG. 10 is a first example structure diagram of the second device for processing the D2D measurement according to an embodiment of the disclosure;

FIG. 11 is a second example structure diagram of the second device for processing the D2D measurement according to an embodiment of the disclosure;

FIG. 12 is a third example structure diagram of the second device for processing the D2D measurement according to an embodiment of the disclosure;

FIG. 13 is a scenario diagram of the example method embodiment 1 of the disclosure;

FIG. 14 is a flowchart of an example method embodiment 1 of the disclosure;

FIG. 15 is a flowchart of an example method embodiment 2 of the disclosure;

FIG. 16 is a flowchart of an example method embodiment 3 of the disclosure;

FIG. 17 is a scenario diagram of an example method embodiment 4 of the disclosure;

FIG. 18 is a scenario diagram of an example method embodiment 5 of the disclosure;

FIG. 19 is a scenario diagram of an example method embodiment 6 of the disclosure;

FIG. 20 is a flowchart of an example method embodiment 6 of the disclosure; and

FIG. 21 is a flowchart of an example method embodiment 7 of the disclosure.

### DETAILED DESCRIPTION OF THE EMBODIMENTS

The disclosure is described below with reference to the drawings and embodiments in detail. It is important to note that the embodiments of the disclosure and characteristics in the embodiments may be combined under the condition of no conflicts.

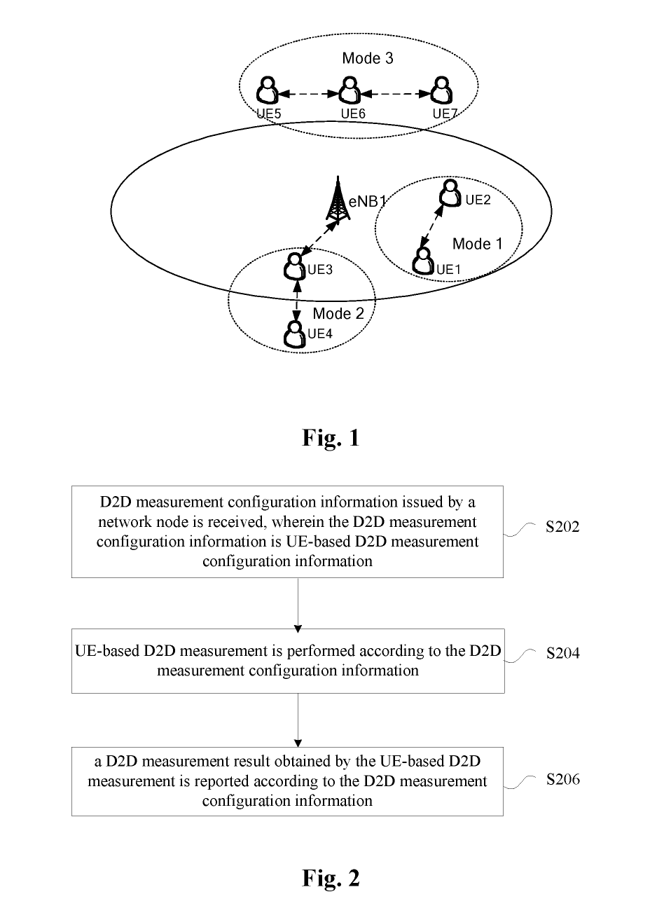

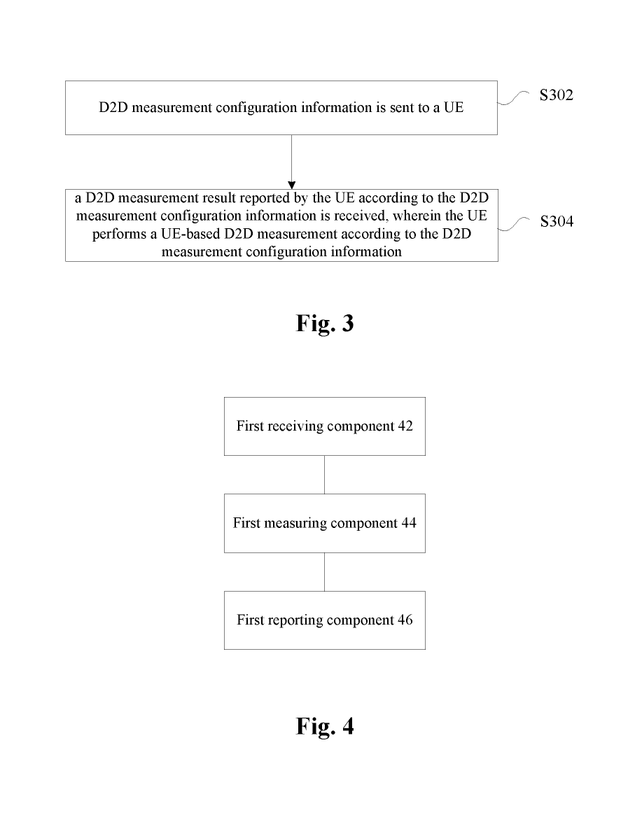

A method for processing a D2D measurement is provided in the embodiment of the present disclosure. FIG. 2 is a first flowchart of the method for processing the D2D measurement according to the embodiment of the disclosure, and as shown in FIG. 2, the flow includes the following steps:

Step 202: D2D measurement configuration information issued by a network node is received, wherein the D2D measurement configuration information is User Equipment (UE)-based D2D measurement configuration information, and the D2D measurement configuration information may include at least one of: UE-based measurement object information, a UE-based measurement reporting condition and a UE-based measurement reporting content;

Step 204: a UE-based D2D measurement is performed according to the D2D measurement configuration information; and

Step 206: a D2D measurement result obtained by the UE-based D2D measurement is reported according to the D2D measurement configuration information.

By the steps, for a UE side, UE performs a measurement and reporting mechanism according to the configured D2D measurement configuration information, and compared with a manner in which the UE performs the measurement and reporting only on the basis of a residing cell or a serving cell and an adjacent cell in the related art, the manner of performing measurement and reporting according to the D2D measurement configuration information is more pertinent, namely for whether the UE may perform D2D communication or not, so that the problem of incapability in effectively controlling D2D discovery and communication in the related art is solved, and moreover, effects of effectively increasing a resource utilization rate and improving quality of user service are achieved.

When the UE-based D2D measurement is performed according to the D2D measurement configuration information, multiple processing manners are adopted according to different states of the UE, and for example, at least one of the following combinations may be adopted: a UE in an RRC idle state performs the UE-based D2D measurement according to the D2D measurement configuration information which is obtained by the UE when the UE is in an RRC idle state; a UE in an RRC idle state performs the UE-based D2D measurement according to the D2D measurement configuration information which is obtained by the UE when the UE is in an RRC connected state; a UE in an RRC connected state performs the UE-based D2D measurement according to the D2D measurement configuration information which is obtained by the UE when the UE is in an RRC idle state; and a UE in an RRC connected state performs the UE-based D2D measurement according to the D2D measurement configuration information which is obtained by the UE when the UE is in an RRC connected state. That is, the D2D measurement configuration information used for performing the UE-based D2D measurement is unrelated to the state of the UE when the D2D measurement configuration information is acquired.

According to different contents indicated by the D2D measurement configuration information, multiple manners may also be adopted for performing the UE-based D2D measurement, and for example, under the condition that the UE-based measurement object information comprised in the D2D measurement configuration information comprises an indicated resource, which comprises at least one of: a time-domain resource, a frequency-domain resource and a code-domain resource, a D2D measurement is performed on a UE using the indicated resource; for another example, under the condition that the UE-based measurement object information in the D2D measurement configuration information comprises identification information used for indicating a measurement object, a D2D measurement is performed on a UE identified by the identification information or a UE used by a user identified by the identification information, wherein there may be various kinds of identification information, and for example, may be at least one of: UE identification information of a friend in an application program of the UE, user identification information of a friend in the application program of the UE, UE identification information of a UE currently performing cellular network communication with the UE and user identification information of a user currently performing cellular network communication with the UE; for a third example, under the condition that the UE-based measurement object information comprised in the D2D measurement configuration information comprises a indicated measurement range, a D2D measurement is performed on a UE within the indicated measurement range, wherein the indicated measurement range may include at least one of: a geographical location range, a signal strength range and a signal quality range; and for a fourth example, under the condition that the UE-based measurement object information comprised in the D2D measurement configuration information comprises an indicated measurement D2D group, a D2D measurement is performed on a UE in the indicated measurement D2D group. It is important to note that the D2D measurement may also be performed on the UE by measuring a D2D signal sent by the UE when the UE-based D2D measurement is performed according to the D2D measurement configuration information. Wherein, the D2D signal may include at least one of: a discovery signal, a reference signal, a synchronization signal, a pilot frequency signal and a preamble signal.

According to different reporting triggering conditions, there may be multiple manners for reporting the D2D measurement result obtained by UE-based D2D measurement according to the UE-based measurement reporting condition, and for example, at least one of the following manners may be adopted: under the condition that the UUE-based measurement reporting condition comprised in the D2D measurement configuration information is a event-based triggering condition, whether the D2D measurement result meets a reporting triggering threshold condition comprised in the UE-based measurement reporting condition or not is judged, and when a judgment result is that the D2D measurement result meets the reporting triggering threshold condition comprised in the UE-based measurement reporting condition, the D2D measurement result is reported; under the condition that the UE-based measurement reporting condition comprised in the D2D measurement configuration information is a periodic triggering condition, the D2D measurement result is reported according to a period indicated in the UE-based measurement reporting condition; under the condition that the UE-based measurement reporting condition comprised in the D2D measurement configuration information is a event-based periodic triggering condition, the D2D measurement result is reported according to a threshold value condition and a period comprised in the UE-based measurement reporting condition; and under the condition that the UE-based measurement reporting condition comprised in the D2D measurement configuration information is a condition of reporting the D2D measurement result at the same time of sending a cellular system measurement report, the D2D measurement result is reported at the same time when the cellular system measurement report is sent. It is important to note that there may also be multiple manners for reporting the D2D measurement result at the same time when the cellular system measurement report is reported, the D2D measurement result may be triggered to be reported at the same time when the cellular system measurement report is triggered for example; and for another example, the D2D measurement result may also be contained in the cellular system measurement report.

In an optional embodiment, the D2D measurement result reported according to the UE-based measurement reporting content may include at least one of: identification information of a UE sending a D2D signal received by a current UE; a D2D signal resource used by a D2D signal received by a current UE; signal strength of a D2D signal received by a current UE; signal quality of a D2D signal received by a current UE; indication information indicating whether a current UE is currently performing cellular communication with a UE sending a D2D signal received by the current UE or not; identification information of a UE currently performing D2D communication with a current UE; indication information about whether a current UE tends to adopt D2D communication or not; and D2D capability information of a current UE. Wherein, the identification information of the UE sending the D2D signal received by the current UE may include at least one of: UE identification information for identifying the UE sending the D2D signal; user identification information for identifying a user using the UE sending the D2D signal; D2D group identification information for identifying a D2D group to which the UE sending the D2D signal belongs; and D2D group identification information for identifying a D2D group to which the user of the UE sending the D2D signal belongs.

In order to enhance the pertinence of the D2D measurement configuration information, after the UE-based D2D measurement configuration information transmitted by the network node is received, the method may further include: under the condition of replacing a residing cell, a measurement configuration indicated by the D2D measurement configuration information received, by a UE in an RRC idle state, in an original residing cell is deleted; or, under the condition that deletion indication information carried in the D2D measurement configuration information transmitted by the network node is received, a measurement configuration corresponding to the deletion indication information received is deleted, wherein the deletion indication information is received by a UE in an RRC connected state.

A method for processing a D2D measurement is provided in the embodiment of the present disclosure, FIG. 3 is a second flowchart of the method for processing the D2D measurement according to an embodiment of the disclosure, and as shown in FIG. 3, the flow includes the following steps:

Step 302: D2D measurement configuration information is sent to a UE, wherein the D2D measurement configuration information is UE-based D2D measurement configuration information, and the D2D measurement configuration information may include at least one of: UE-based measurement object information, a UE-based measurement reporting condition and a UE-based measurement reporting content; and

Step 304: a D2D measurement result reported by the UE according to the D2D measurement configuration information is received, wherein the UE performs a UE-based D2D measurement according to the D2D measurement configuration information.

By the steps, for a network side, a network node configures the UE-based D2D measurement configuration information for the UE, and sends it to the UE, the UE performs a measurement and reporting mechanism according to the configured D2D measurement configuration information, and compared with a manner that the UE performs measurement and reporting only on the basis of a residing cell or a serving cell and an adjacent cell in the related art, the manner of performing measurement and reporting according to the UE-based D2D measurement configuration information is more pertinent, namely for whether the UE may perform D2D communication or not, so that the problem of incapability in effectively controlling D2D discovery and communication in the related art is solved, and moreover, effects of effectively increasing a resource utilization rate and improving quality of user service are achieved.

In order to improve discovery signal detection efficiency of the UE to further increase a D2D discovery speed and save power of the UE, before the UE-based D2D measurement configuration information is sent to the UE, location information of the UE in a cell may be determined at first; and the D2D measurement configuration information is configured for the UE according to the location information of the UE in the cell.

In an example manner, when the network side configures the D2D measurement configuration information for the UE before the D2D measurement configuration information is sent to the UE, wherein the D2D measurement configuration information is UE-based D2D measurement configuration information, multiple processing manners may be correspondingly adopted according to different considered factors, and for example, the D2D measurement configuration information may be configured for the UE according to information received from a D2D server; for another example, the D2D measurement configuration information may be configured for the UE according to a network burden reduction requirement; for a third example, the D2D measurement configuration information may be configured for the UE according to a power-saving requirement of the UE; and for a fourth example, the D2D measurement configuration information may be configured for the UE according to a QoS requirement of the UE.

In an optional example, there may also be multiple manners for sending the D2D measurement configuration information to the UE, and for example, the D2D measurement configuration information may be sent to the UE in a system broadcasting manner and/or in a dedicated signalling manner. Wherein, the step that the D2D measurement configuration information is sent to the UE in the system broadcasting manner includes: at least one of the following information is broadcast in the system broadcasting manner: a time-domain resource available for the UE in a cell of a network node, a frequency-domain resource available for the UE in the cell of the network node, a code-domain resource available for the UE in the cell of the network node and identification information available for the UE in the cell of the network node.

More preferably, after the D2D measurement result reported by the UE according to the D2D measurement configuration information is received, multiple processing may also be performed according to the D2D measurement result, and for example, D2D discovery operation may be performed according to the D2D measurement result; D2D communication operation may also be performed according to the D2D measurement result; whether to initiate a D2D connection establishment process for the UE or not may also be judged according to the D2D measurement result, and under the condition that a judgement result is to initiate the D2D connection establishment process for the UE, the D2D connection establishment process is initiated; whether to convert a communication manner of the UE from cellular communication into D2D communication or not may also be judged according to the D2D measurement result, and under the condition that a judgement result is to convert the communication manner of the UE from the cellular communication into the D2D communication, the communication manner of the UE is converted from the cellular communication into D2D communication; and whether to convert the communication manner of the UE from the D2D communication into the cellular communication or not may also be judged according to the D2D measurement result, and under the condition that a judgment result is to convert the communication manner of the UE from the D2D communication into the cellular communication, the communication manner of the UE is converted from the D2D communication into the cellular communication.

A device for processing a D2D measurement is provided in the embodiment of the present disclosure, which is configured to implement the abovementioned embodiment and example implementation modes, and that what has been described will not be repeated. For example, a term “component”, used below, is a combination of software and/or hardware capable of realizing preset functions. The device described in the following embodiment is preferably implemented by software, but the implementation of the device with hardware or the combination of software and hardware is also possible and conceivable.

FIG. 4 is a structure diagram of a first device for processing a D2D measurement according to an embodiment of the disclosure, and as shown in FIG. 4, the device includes a first receiving component 42, a first measuring component 44 and a first reporting component 46. The device is described below.

The first receiving component 42 is configured to receive D2D measurement configuration information issued by a network node, wherein the D2D measurement configuration information is based on a UE; the first measuring component 44 is connected to the first receiving component 42, and is configured to perform a UE-based D2D measurement according to the D2D measurement configuration information; and the first reporting component 46 is connected to the first measuring component 44, and is configured to report, according to the D2D measurement configuration information, a D2D measurement result obtained by the UE-based D2D measurement.

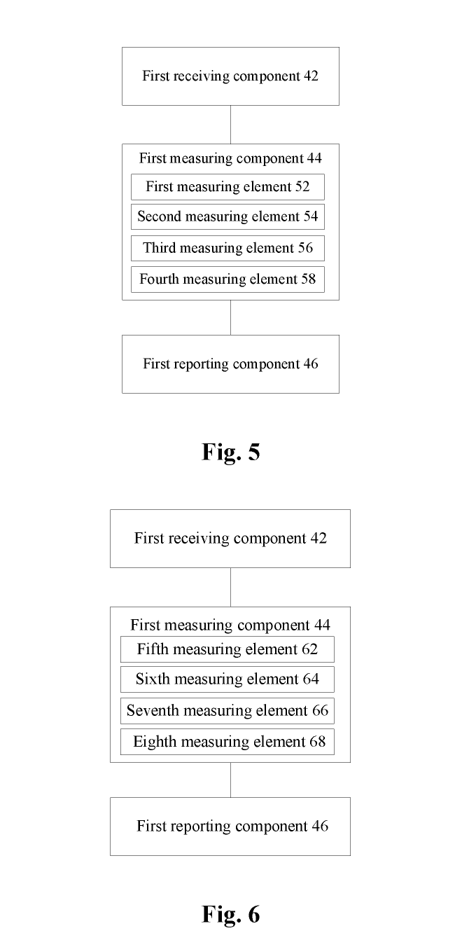

FIG. 5 is a first example structure diagram of the first measuring component 44 in the first device for processing the D2D measurement according to an embodiment of the disclosure, and as shown in FIG. 5, the first measuring component 44 includes at least one of: a first measuring element 52, a second measuring element 54, a third measuring element 56 and a fourth measuring element 58. The first measuring component 44 is described below.

The first measuring element 52 is configured for a UE in an RRC idle state to perform the UE-based D2D measurement according to the D2D measurement configuration information which is obtained by the UE when the UE is in an RRC idle state; the second measuring element 54 is configured for the UE in the RRC idle state to perform UE-based D2D measurement according to the D2D measurement configuration information which is obtained by the UE when the UE is in an RRC connected state; the third measuring element 56 is configured for the UE in an RRC connected state to perform the UE-based D2D measurement according to the D2D measurement configuration information which is obtained by the UE when the UE is in an RRC idle state; and the fourth measuring element 58 is configured for the UE in an RRC connected state to perform the UE-based D2D measurement according to the D2D measurement configuration information which is obtained by the UE when the UE is in an RRC connected state.

FIG. 6 is a second example structure diagram of the first measuring component 44 in the first device for processing the D2D measurement according to an embodiment of the disclosure, and as shown in FIG. 6, the first measuring component 44 includes at least one of: a fifth measuring element 62, a sixth measuring element 64, a seventh measuring element 66 and an eighth measuring element 68. The first measuring component 44 is described below.

The fifth measuring element 62 is configured to, under the condition that the UE-based measurement object information comprised in the D2D measurement configuration information comprises an indicated resource, which comprises at least one of: a time-domain resource, a frequency-domain resource and a code-domain resource, perform a D2D measurement on a UE using the indicated resource; the sixth measuring element 64 is configured to, under the condition that the UE-based measurement object information comprised in the D2D measurement configuration information comprises identification information used for identifying a measurement object, perform a D2D measurement on a UE identified by the identification information or a UE used by a user identified by the identification information; the seventh measuring element 66 is configured to, under the condition that the UE-based measurement object information comprised in the D2D measurement configuration information comprises a indicated measurement range, perform a D2D measurement on a UE within the indicated measurement range; and the eighth measuring element 68 is configured to, under the condition that the UE-based measurement object information comprised in the D2D measurement configuration information comprises an indicated measurement D2D group, perform a D2D measurement on a UE in the indicated measurement D2D group.

In an example embodiment, the first measuring component 44 is further configured to perform a D2D measurement on the UE by measuring a D2D signal sent by the UE.

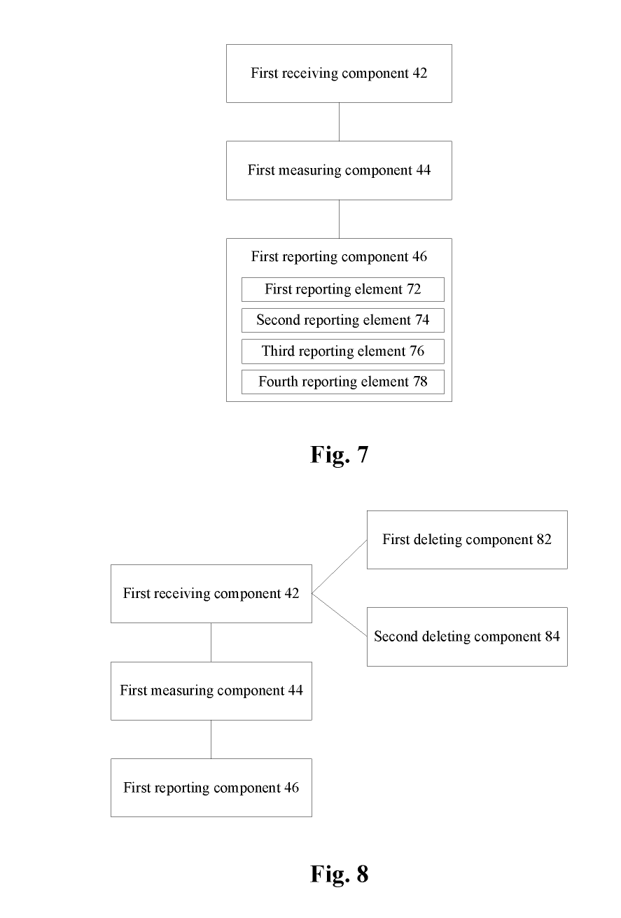

FIG. 7 is an example structure diagram of the first reporting component 46 in the first device for processing the D2D measurement according to an embodiment of the disclosure, and as shown in FIG. 7, the first reporting component 46 includes at least one of: a first reporting element 72, a second reporting element 74, a third reporting element 76 and a fourth reporting element 78. The first reporting component 46 is described below.

The first reporting element 72 is configured to, under the condition that the UE-based measurement reporting condition comprised in the D2D measurement configuration information is a event-based triggering condition, judge whether the D2D measurement result meets a reporting triggering threshold condition comprised in the UE-based measurement reporting condition or not, and when a judgment result is that the D2D measurement result meets the reporting triggering threshold condition comprised in the UE-based measurement reporting condition, report the D2D measurement result; the second reporting element 74 is configured to, under the condition that the UE-based measurement reporting condition comprised in the D2D measurement configuration information is a periodic triggering condition, report the D2D measurement result according to a period indicated in the UE-based measurement reporting condition; the third reporting element 76 is configured to, under the condition that the UE-based measurement reporting condition comprised in the D2D measurement configuration information is a event-based periodic triggering condition, report the D2D measurement result according to a threshold value condition and a period comprised in the UE-based measurement reporting condition; and the fourth reporting element 78 is configured to, under the condition that the UE-based measurement reporting condition comprised in the D2D measurement configuration information is a condition of reporting the D2D measurement result at the same time of sending a cellular system measurement report, report the D2D measurement result at the same time when the cellular system measurement report is sent.

FIG. 8 is an example structure diagram of the first device for processing the D2D measurement according to an embodiment of the disclosure, and as shown in FIG. 8, the device further includes a first deleting component 82 or a second deleting component 84, except all the components shown in FIG. 4. The example device is described below.

The first deleting component 82 is configured to, under the condition of replacing a residing cell, delete a measurement configuration indicated by the D2D measurement configuration information received, by a UE in an RRC idle state, in an original residing cell; or, the second deleting component 84 is configured to, under the condition that deletion indication information carried in the D2D measurement configuration information transmitted by the network node is received, delete a measurement configuration corresponding to the deletion indication information, wherein the deletion indication information is received by a UE in an RRC connected state.

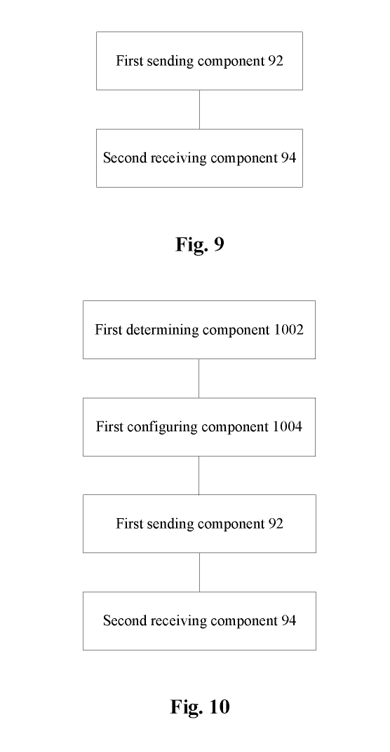

A device for processing a D2D measurement is further provided in the embodiment of the present disclosure, FIG. 9 is a structure diagram of a second device for processing a D2D measurement according to an embodiment of the disclosure, and as shown in FIG. 9, the device includes: a first sending component 92 and a second receiving component 94. The device is described below.

The first sending component 92 is configured to send D2D measurement configuration information to a UE, wherein the D2D measurement configuration information is based on the UE; and the second receiving component 94 is connected to the first sending component 92, and is configured to receive a D2D measurement result reported by the UE according to the D2D measurement configuration information, wherein the UE performs a UE-based D2D measurement according to the D2D measurement configuration information.

FIG. 10 is a first example structure diagram of the second device for processing the D2D measurement according to an embodiment of the disclosure, and as shown in FIG. 10, the device further includes a first determining component 1002 and a first configuring component 1004, except all the components shown in FIG. 9. The example device is described below.

The first determining component 1002 is configured to determine location information of the UE in a cell; and the first configuring component 1004 is connected to the first determining component 1002 and the first sending component 92, and is configured to configure the D2D measurement configuration information for the UE according to the location information of the UE in the cell.

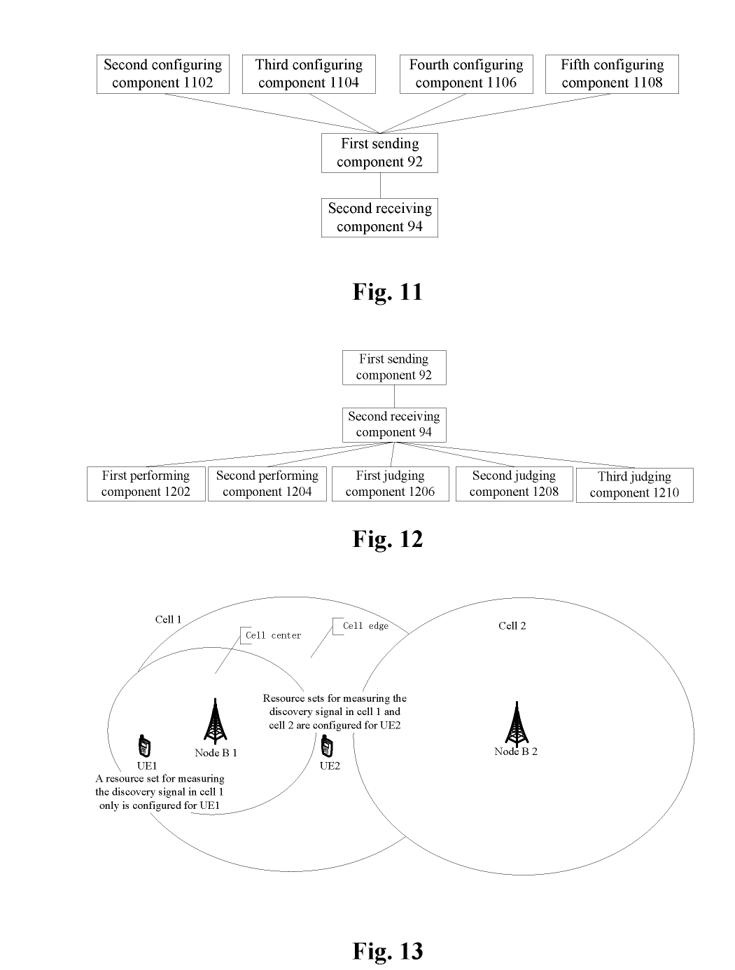

FIG. 11 is a second example structure diagram of the second device for processing the D2D measurement according to an embodiment of the disclosure, and as shown in FIG. 11, the device further includes at least one of: a second configuring component 1102, a third configuring component 1104, a fourth configuring component 1106 and a fifth configuring component 1108, except all the components shown in FIG. 9. The example device is described below.

The second configuring component 1102 is configured to configure the D2D measurement configuration information for the UE according to information received from a D2D server; the third configuring component 1104 is configured to configure the D2D measurement configuration information to the UE according to a network burden reduction requirement; the fourth configuring component 1106 is configured to configure the D2D measurement configuration information for the UE according to a power-saving requirement of the UE; and the fifth configuring component 1108 is configured to configure the D2D measurement configuration information for the UE according to a QoS requirement of the UE.

FIG. 12 is a third example structure diagram of the second device for processing the D2D measurement according to an embodiment of the disclosure, and as shown in FIG. 12, the device further includes at least one of: a first performing component 1202, a second performing component 1204, a first judging component 1206, a second judging component 1208 and a third judging component 1210, except all the components shown in FIG. 9. The example device is described below.

The first performing component 1202 is configured to perform a D2D discovery operation according to the D2D measurement result; the second performing component 1204 is configured to perform a D2D communication operation according to the D2D measurement result; the first judging component 1206 is configured to judge whether to initiate a D2D connection establishment process for the UE or not according to the D2D measurement result, and under the condition that a judgement result is to initiate the D2D connection establishment process for the UE, initiate the D2D connection establishment process; the second judging component 1208 is configured to judge whether to convert a communication manner of the UE from cellular communication into D2D communication or not according to the D2D measurement result, and under the condition that a judgement result is to convert the communication manner of the UE from the cellular communication into the D2D communication, convert the communication manner of the UE from the cellular communication into the D2D communication; and the third judging component 1210 is configured to judge whether to convert the communication manner of the UE from the D2D communication into the cellular communication or not according to the D2D measurement result, and under the condition that a judgment result is to convert the communication manner of the UE from the D2D communication into the cellular communication, convert the communication manner of the UE from the D2D communication into the cellular communication.

By the abovementioned embodiment and example implementation modes, the UE-based D2D measurement and UE-based D2D reporting is implemented in a cellular system, and compared with the related art, such a manner may realize the advantage that an operator network may configure the corresponding D2D measurement and reporting mechanism for the UE so as to assist, manage and control the D2D discovery and D2D communication processes of the D2D UE, increase the resource utilization rate and improve the quality of the user service.

The embodiment of the disclosure is described below from a user side and a network side.

In an example embodiment of the disclosure, a measurement and reporting method is disclosed, which includes: UE performs D2D measurement according to D2D measurement configuration information, wherein the D2D measurement configuration information may include at least one of: measurement object information, a measurement reporting condition and a measurement reporting content; and the UE sends a measurement report including a D2D measurement result to a network node according to the D2D measurement configuration information. Wherein, the D2D measurement configuration information is configuration information sent to the UE used for related D2D measurement by an access side network element of a cellular network.

In an optional embodiment, the access side network element of the cellular network may send the D2D measurement configuration information to the UE in a manner as follows: the access side network element of the cellular network sends the D2D measurement configuration information to the UE in a system broadcast message manner; and/or, the access side network element of the cellular network sends the D2D measurement configuration information to the UE in a dedicated signalling manner.

Wherein, the following manners may be adopted for the access side network element of the cellular network to send the D2D measurement configuration information in the system broadcast message manner: the access side network element of the cellular network broadcasts at least one of the following resource set available for UE in the local cell: a time-domain resource set, a frequency-domain resource set, a code-domain resource set; the access side network element of the cellular network broadcasts an identification information list available for the UE in the local cell; and the identification information is a device Identifier (ID) or a discovery ID or other information for identifying the UE.

Wherein, after the access side network element of the cellular network sends the D2D measurement configuration information to the UE in the system broadcast message manner, the method may further include: the UE deletes a D2D measurement configuration obtained from an original residing cell after residing to another cell by cell reselection.

After the access side network element of the cellular network sends the D2D measurement configuration information to the UE in the dedicated signalling manner, the method may further include: the access side network element of the cellular network may indicate the UE to delete the D2D measurement configuration in the dedicated signalling manner.

In an optional manner, when the UE performs D2D measurement according to the D2D measurement configuration information, the UE may be UE in an RRC idle state or UE in an RRC connected state.

In an optional manner, when the UE performs D2D measurement according to the D2D measurement configuration information, the UE in the RRC idle state may perform the D2D measurement according to the D2D measurement configuration information which is obtained by the UE when the UE is in the RRC connected state; or, the UE in the RRC connected state may also perform the D2D measurement according to the D2D measurement configuration information which is obtained by the UE when the UE is in the RRC idle state.

In an optional embodiment, the UE performs the D2D measurement according to the D2D measurement configuration information includes: the UE performs the measurement on a measurement object corresponding to the measurement object information comprised in the D2D measurement configuration information.

Wherein, the UE performs the measurement on a measurement object corresponding to the measurement object information in the D2D measurement configuration information includes: when at least one of the following resource set is indicated in the measurement object information: a time-domain resource set, a frequency-domain resource set, a code-domain resource set, the UE performs the measurement on an adjacent UE using the resource indicated in the measurement object information, wherein it is important to note that the resource set includes a specific resource or resource pool; when the measurement object information includes an identification information list of one or more to-be-measured objects, the UE performs a measurement on an adjacent UE identified by identification information indicated in the measurement object information, wherein the identification information list may include one or more pieces of identification information, and the identification information may comprise device identification information or discovery identification information or other information for identifying the UE; when the measurement object information indicates a to-be-measured range, the UE performs measurement on an adjacent UE within the range indicated in the measurement object information, wherein the range may be a geographical location range, or a signal strength range, or a signal quality range; and when the measurement object information indicates to-be-measured D2D group information, the UE performs measurement on an adjacent UE in a D2D group indicated in the measurement object information, wherein the D2D group information may be D2D group identification information or other D2D group information.

Wherein, the UE performs the measurement on the corresponding measurement object according to the measurement object information in the D2D measurement configuration information includes: the UE performs the measurement on the corresponding measurement object by measuring a D2D signal sent by the measurement object. Wherein, the D2D signal refers to a signal for a D2D discovery or D2D communication process, and includes, but not limited to, at least one of: a discovery signal, a reference signal, a synchronization signal, a pilot frequency signal and a preamble signal. Under the condition that the measurement object information indicates at least one of the following resource set: a time-domain resource set, a frequency-domain resource set, a code-domain resource set, the resource set is a resource set available for the UE in a serving cell of the UE and/or an adjacent cell of the serving cell of the UE to send the D2D signal.

In an optional manner, the access side network element (network node) may determine whether the UE is located in a central area of the cell or not according to a measurement report of the UE or geographical location information of the UE. When the UE is located in an edge area of the cell, the adjacent cell of the UE may further be determined, then at least on the following resource set used by the UE may be determined: the time-domain resource set, the frequency-domain resource set, the code-domain resource set, and then the resource set is sent to the UE according to the measurement object information in the measurement configuration information.

Wherein, under the condition that the measurement object information includes the identification information list of the one or more to-be-measured objects, the identification information list includes, but not limited to: UE identification information of a friend in an dedicated application program of the UE; or, user identification information of the second UE currently communicating with the UE through the cellular network.

In an optional manner, the UE sends the measurement report including the D2D measurement result to the network node according to the D2D measurement configuration information includes: the UE triggers sending of the measurement report according to measurement reporting condition information comprised in the D2D measurement configuration information; the UE triggers the sending of the measurement report according to the measurement reporting condition information comprised in the D2D measurement configuration information includes: under the condition that a measurement reporting condition is a event-based triggering condition, the measurement reporting condition information includes threshold information corresponding to an event which triggers the sending of the D2D measurement report, and the UE determines whether to trigger the sending of the D2D measurement report or not according to a predefined rule after comparing the D2D measurement result with the threshold; under the condition that the measurement reporting condition is a periodic triggering condition, the measurement reporting condition information at least includes period information of triggering the sending of the D2D measurement report, and the UE periodically triggers the sending of the D2D measurement report according to the period information; and under the condition that the measurement reporting condition is a event-based periodic triggering condition, the measurement reporting condition information includes the threshold information corresponding to the event which triggers the sending of the D2D measurement report and the period information of triggering the sending of the D2D measurement report, and the UE triggers the sending of the D2D measurement report according to the threshold and the period information.

In an optional manner, the UE triggers the sending of the measurement report according to the measurement reporting condition information comprised in the D2D measurement configuration information includes: the UE is indicated by the D2D measurement configuration information to trigger the D2D measurement report at the same time of triggering a cellular system measurement report; or, the UE is indicated by the D2D measurement configuration information to carry a D2D measurement report content in the cellular system measurement report. Wherein, the UE sends the measurement report including the D2D measurement result to the network node according to the D2D measurement configuration information includes: the UE carries a to-be-reported content in the measurement report to report to the network node according to the measurement reporting content information comprised in the measurement configuration information; and the UE is indicated by the measurement reporting content information to carry related D2D information in the D2D measurement report.

It is important to note that the D2D measurement report includes at least one of: identification information related to a UE sending a D2D signal received by a current UE; a D2D signal resource used by a D2D signal received by a current UE; signal strength of a D2D signal received by a current UE; signal quality of a D2D signal received by a current UE; indication information indicating whether a current UE is currently performing cellular communication with a UE sending a D2D signal received by the current UE or not; identification information related to the second UE currently performing D2D communication with a current UE; indication information about whether a current UE tends to adopt D2D communication or not; and D2D capability information of a current UE. The identification information related to the UE includes, but not limited to: device identification information or discovery identification information of the UE or other information for identifying the UE; identification information of a user using the UE; and identification information of a D2D group to which the UE or the user using the UE belongs.

In an optional manner, after the UE sends the measurement report including the D2D measurement result to the network node according to the D2D measurement configuration information, the method further includes at least one of the following steps: the network node performs subsequent D2D discovery operation according to the measurement report of the UE; the network node judges whether to initiate a D2D connection establishment process for the UE or not according to the measurement report of the UE; the network node judges whether it is necessary to convert a communication manner of the UE from the cellular communication into the D2D communication or not according to the measurement report of the UE; and the network node judges whether it is necessary to convert the communication manner of the UE from the D2D communication into the cellular communication or not according to the measurement report of the UE.

It is important to point out that the access side network element of the cellular network may configure the D2D measurement configuration information for the UE according to information sent by a D2D server. The access side network element of the cellular network may also autonomously configure the D2D measurement configuration information for the UE, wherein the access side network element of the cellular network autonomously configures the D2D measurement configuration information to the UE includes: the access side network element of the cellular network configures the D2D measurement configuration information for the UE according to a network burden reduction requirement; the access side network element of the cellular network configures the D2D measurement configuration information for the UE according to a power-saving requirement and/or QoS requirement of the UE. Wherein, the access side network element may further acquire the power-saving requirement and/or the QoS requirement of the UE in at least one of manners as follows: the UE sends the power-saving requirement and/or the QoS requirement to the access side network element; the UE sends the power-saving requirement and/or the QoS requirement to the D2D server, and then the D2D server sends the power-saving requirement and/or the QoS requirement of the UE to the access side network element; and the access side network element acquires the power-saving requirement and/or the QoS requirement of the UE according to context information, stored by itself, of the UE.

Wherein, the network node may be the access side network element of the cellular network. The D2D server may be a server available for a D2D use.

By the abovementioned embodiment and example implementation modes, problems about measurement and reporting for a D2D technology in a cellular system are solved, and by the method, an operator network may configure a corresponding D2D measurement and reporting mechanism to the UE so as to further assist, manage and control the D2D discovery and D2D communication processes of the D2D UE, increase a resource utilization rate and improve the quality of user service.

Description is given below with reference to the example embodiments of the disclosure.

### METHOD EMBODIMENT 1

The embodiment describes a method for measurement and reporting under the condition that a resource used by a to-be-measured object is configured for UE by a Node B. FIG. 13 is a scenario diagram of the example method embodiment 1 of the disclosure, and as shown in FIG. 13, cell 1 and cell 2 are adjacent cells, and UE1 and UE2 access Node B1, and are served by cell 1. In order to conveniently acquire a serving Node B or cell of an opposite D2D UE sending a discovery signal received by a current UE, it is supposed that different discovery signal resource sets are adopted for the adjacent cells, that is, the UE in cell 1 and the UE in cell 2 send D2D discovery signals by virtue of different resource sets. In such a manner, the adjacent Node Bs are required to interact and negotiate to make different cells adopt different discovery signal resource sets, and the Node Bs are also required to acquire the discovery signal resource sets adopted by the adjacent cells, and for example, an X2 interface message may be adopted for interaction, negotiation and acquisition.

It is important to note that the resources for sending the D2D discovery signals in the example embodiment include at least one of the following: a time-domain resource, a frequency-domain resource, a code-domain resource.

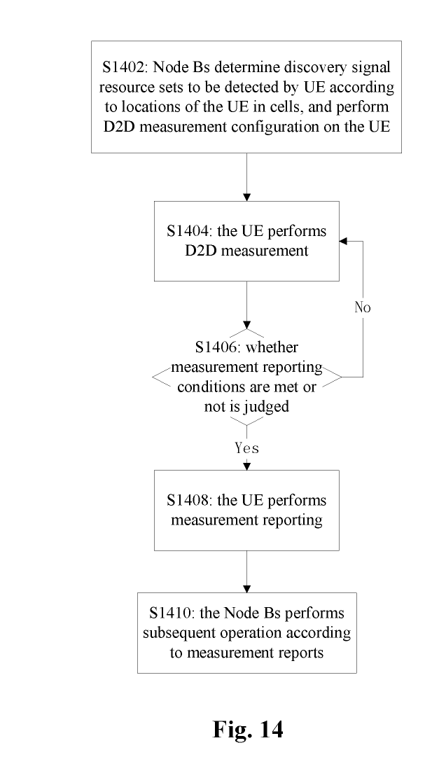

FIG. 14 is a flowchart of an example method embodiment 1 of the disclosure, and as shown in FIG. 14, the flow includes the following steps:

Step 1402: the Node Bs determine the discovery signal resource sets to be detected by the UE according to locations of the UE in the cells, and perform D2D measurement configuration for the UE, that is, the Node Bs determine the resource sets for discovery signals to be measured by the UE according to the locations of the UE in the cells, so that discovery signal detection efficiency of the UE may be improved to further increase a D2D discovery speed and save power of the UE. Specifically, the Node Bs may judge whether the UE is located in central areas of the cells or edge areas of the cells, and when the UE is located in the edge areas of the cells, the Node Bs may further determine adjacent cells of the UE. The Node Bs may determine the locations of the UE in the cells in manners as follows.

1) The locations of the UE in the cells are determined according to measurement reports of the UE. The UE may report signal strength or signal quality (for example, Reference Signal Received Power (RSRP), Reference Signal Received Quality (RSRQ), Signal to Noise Ratio (SNR) and Signal to Interference plus Noise Ratio (SINR) of their serving cells on the basis of configurations by the Node Bs, and when the signal strength or signal quality of the UE in the serving cells reaches a certain specific threshold, it may be considered that the UE is located in the central areas of the cells; and when the signal strength or signal quality of the UE in the serving cells is lower than a certain specific threshold, it may be considered that the UE is located in the edge areas of the cells. For the UE located in the edge areas of the cells, the Node Bs may also determine the adjacent cells of the UE according to the measurement reports of the UE about signal strength or signal quality of the adjacent cells. If the signal strength or signal quality of the adjacent cells is measured by the UE to be higher than a certain specific threshold, it may be considered that the UE is located in the vicinity of the adjacent cells.

2) The locations of the UE in the cells are determined according to geographical location information of the UE. For example, the Node Bs may determine geographical locations of the UE according to a locating method at first, then determine whether the UE is located in the central areas of the cells or not according to a network topology structure and determine the adjacent cells of the UE when the UE is located in the edge areas of the cells.

In the preferred embodiment, when Node B1 determines that UE1 is located in the central area of the cell and performs related D2D measurement configuration on UE1, it is configured that UE1 is only required to measure the discovery signal resource set in the serving cell (i.e. cell 1) and is not required to measure the discovery signal resource set in the other adjacent cell. For UE2, when the Node B determines that UE2 is located in the edge area of the cell, further determines that an adjacent cell of UE2 is cell 2 and performs related D2D measurement configuration on UE2, it is configured that UE2 is required to measure the discovery signal resource sets in the serving cell (i.e. cell 1) and the adjacent cell (cell 2).

Step 1404: the UE performs D2D measurement, UE1 and UE2 performs a D2D measurement on the adjacent D2D UE according to measurement objects configured by the Node Bs, receive the D2D discovery signals and measure their signal strength, signal quality and the like. Wherein, UE1 and UE2 may perform the D2D measurement on the adjacent D2D UE in an RRC idle state or an RRC connected state.

Step 1406: UE1 and UE2 judge whether measurement reporting conditions are met or not, enter Step 1408 when the measurement reporting conditions are met, otherwise return to Step 1404, that is, UE1 and UE2 report a measurement result to the Node Bs through measurement reports on the basis of the measurement reporting conditions comprised in the D2D measurement configurations of the Node Bs when the corresponding conditions are met after the discovery signals are detected and measured. The measurement reporting conditions include the following three types: event-based triggering, periodic triggering and event-based periodic triggering, specifically as follows:

1) when the measurement reporting conditions configured for the UE by the Node Bs are event-based triggering, measurement reporting condition information includes threshold information corresponding to an event rule which triggers reporting of D2D measurement results, and the UE determines whether to trigger the reporting of the D2D measurement results or not according to the predefined event rules after comparing the D2D measurement results with received threshold.

2) when the measurement reporting conditions configured for the UE by the Node Bs are periodic triggering, the measurement reporting condition information at least includes period information of triggering the reporting of the D2D measurement results, and the UE periodically triggers the reporting of the D2D measurement results according to the period information.

3) when the measurement reporting conditions configured for the UE by the Node Bs are event-based periodic triggering, the measurement reporting condition information includes the threshold information corresponding to events which trigger the reporting of the D2D measurement results and the period information of triggering the reporting of the D2D measurement results, and the UE triggers the reporting of the D2D measurement results according to the threshold information and the period information.

Step 1408: the UE performs measurement reporting, that is, the UE performs D2D measurement and reports the D2D measurement results to the Node Bs through the measurement reports when the corresponding measurement reporting conditions are met. The measurement reports may include the following contents:

1) identification information of the measured UE, wherein the identification information may be a D2D device ID, a D2D discovery ID, a D2D UE ID, a Cell Radio Network Temporary Identifier (C-RNTI), an S-Temporary Mobile Subscriber Identity (S-TMSI), an International Mobile Subscriber Identity (IMSI), an Internet Protocol (IP) address and the like;

2) resources used by the discovery signals received by the UE;

3) the signal strength of the discovery signals received by the UE;

4) the signal quality of the discovery signals received by the UE, such as SNR;

5) indication information indicating whether the UE is currently performing cellular communication with the UE sending the received discovery signals or not;

6) indication information about whether the UE tends to adopt D2D communication or not; and

7) D2D capability information of the UE.

Step 1410: the Node Bs performs subsequent operation according to the measurement reports, that is, the Node Bs may perform subsequent operation according to the measurement reports of the UE after receiving the measurement reports, including:

1) the Node Bs performs subsequent D2D discovery operation according to the measurement reports of the UE;

2) or, the Node Bs judges whether to initiate D2D connection establishment processes for the UE or not according to the measurement reports of the UE;

3) or, the Node Bs judges whether it is necessary to convert the cellular communication between the UE and the opposite UE into D2D communication or not according to the measurement reports of the UE.

### METHOD EMBODIMENT 2

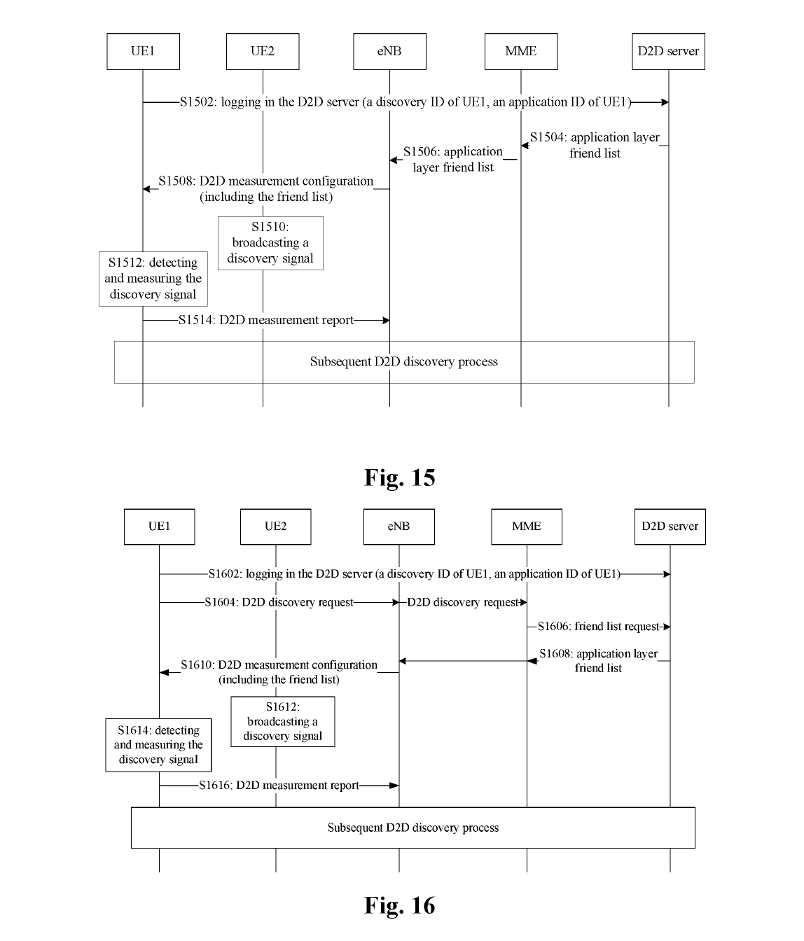

The embodiment describes a method for measurement and reporting under the condition that a to-be-measured object configured for UE by a Node B is identification information. FIG. 15 is a flowchart of an example method embodiment 2 of the disclosure, and as shown in FIG. 15, the flow includes the following steps:

Step 1502: a user starts a certain D2D application program on UE1, and logs in a D2D server. UE1 sends its own identification information contained in a discovery signal and an application ID in the D2D application program to the D2D server in a login process. Wherein, the identification information of the UE in the discovery signal may be a D2D device ID, a D2D discovery ID, a D2D UE ID, a C-RNTI, an S-TMSI, an IMSI, an IP address and the like, and is called a discovery ID for short in the embodiment.

Step 1504: the D2D server may store the discovery ID and application ID of the UE and send a friend list of the UE in the application program to a network element in a cellular network. In the embodiment, the D2D server sends an application layer friend list of the UE to a Mobility Management Entity (MME) of the UE. Specifically, the friend list at least includes a discovery ID list of friends of the UE.

Step 1506: the MME sends the application layer friend list of the UE to a Node B. In addition, when there is a direct interface between the D2D server and the Node B, the D2D server may directly send the application layer friend list of the UE to the Node B.

Step 1508: the Node B performs D2D measurement configuration on UE1 according to the application layer friend list of the UE to configure measurement objects of the UE into an identification information list of the friends of the UE in the application program. The identification information list configured for the UE by the Node B at least includes the discovery ID list.

Step 1510: UE2 sends a discovery signal for D2D discovery in a broadcasting manner.

Step 1512: UE1 detects the discovery signal, and performs corresponding measurement on the detected discovery signal to obtain a measurement result of signal strength, signal quality and the like. Wherein, UE1 may perform D2D measurement on the adjacent D2D UE in an RRC idle state or an RRC connected state.

Step 1514: UE1 judges whether a measurement reporting condition is met or not according to a D2D measurement configuration signal configured by the Node B, and reports the D2D measurement result to the Node B through a D2D measurement report after the corresponding condition is met. The measurement reporting condition includes the following three types: event-based triggering, periodic triggering and event-based periodic triggering, specifically as follows:

1) when the measurement reporting condition configured for the UE by the Node B is event-based triggering, measurement reporting condition information includes threshold information corresponding to an event rule which triggers reporting of the D2D measurement result, and the UE determines whether to trigger the reporting of the D2D measurement result or not according to the predefined event rule after comparing the D2D measurement result with a received threshold.

2) when the measurement reporting condition configured for the UE by the Node B is periodic triggering, the measurement reporting condition information at least includes period information of triggering the reporting of the D2D measurement result, and the UE periodically triggers the reporting of the D2D measurement result according to the period information.

3) when the measurement reporting condition configured for the UE by the Node B is event-based periodic triggering, the measurement reporting condition information includes the threshold information corresponding to an event which triggers the reporting of the D2D measurement result and the period information of triggering the reporting of the D2D measurement result, and the UE triggers the reporting of the D2D measurement result according to the threshold and the period information.

The measurement report may include the following contents:

1) a D2D discovery ID of the measured UE;

2) a resource used by the discovery signal received by the UE;

3) the signal strength of the discovery signal received by the UE;

4) the signal quality of the discovery signal received by the UE, such as SNR;

5) indication information indicating whether the UE is currently performing cellular communication with the UE sending the received discovery signal or not;

6) indication information about whether the UE tends to adopt D2D communication or not; and

7) D2D capability information of the UE. The Node B may perform subsequent operation according to the measurement report of the UE after receiving the measurement report. For example, when the measurement report of UE1 includes information such as identification information and signal quality/strength of UE2, the Node B subsequently sends the information of UE2 to the MME to perform network side verification to determine whether UE1 and UE2 may perform D2D mutual discovery or not.

### METHOD EMBODIMENT 3

The embodiment describes another method for measurement and reporting under the condition that a to-be-measured object configured for UE by a Node B is identification information. FIG. 16 is a flowchart of an example method embodiment 3 of the disclosure, and as shown in FIG. 16, the flow includes the following steps:

Step 1602: a user starts a certain D2D application program on UE1, and logs in a D2D server. UE1 sends its own identification information contained in a discovery signal and an application ID in the D2D application program to the D2D server in a login process. The D2D server may store the discovery ID and application ID of the UE. Wherein, the identification information of the UE in the discovery signal may be a D2D device ID, a D2D discovery ID, a D2D UE ID, a C-RNTI, an S-TMSI, an IMSI, an IP address and the like, and is called a discovery ID for short in the embodiment.

Step 1604: UE1 sends a D2D discovery request message to a network side. Optionally, the message includes the discovery ID of UE1. Optionally, the message explicitly or implicitly indicates identification information of the application program used by UE1. When there is an interface between a Node B and the D2D server, UE1 sends the D2D discovery request message to the Node B; and when there is no interface between the Node B and the D2D server and there is an interface between an MME or a Home Subscriber Server (HSS) and the D2D server, UE1 is required to send the D2D discovery request message to the MME, and UE1 may send the D2D discovery request message to the MME through a Non-Access Stratum (NAS) message, and may also send the D2D discovery request message to the Node B through an air interface, and then the Node B sends the D2D discovery request message to the MME through an S1 message.

Step 1606: when there is an interface between the Node B and the D2D server, the Node B sends a friend list request to the D2D server. When there is no interface between the Node B and the D2D server and there is an interface between the MME or the HSS and the D2D server, the MME (or the MME, through the HSS) sends the friend list request to the D2D server. Wherein, the friend list request at least includes the discovery ID of UE1.

Step 1608: the D2D server contains a friend list of UE1 which logs in the D2D server in the application program in a friend list response for returning to a network side network element. The friend list at least includes discovery IDs of friends of UE1 in the application program. Wherein, the network side network element may comprise the Node B or the MME or the HSS. When the D2D server sends the friend list to the MME, the MME is required to send the friend list to the Node B; and when the D2D server sends the friend list to the HSS, the HSS is required to send the friend list to the MME, and then the MME sends the friend list to the Node B.

Step 1610: the Node B performs D2D measurement configuration on UE1 according to the application layer friend list of the UE to configure measurement objects of the UE into an identification information list of the friends of the UE in the application program. The identification information list configured for the UE by the Node B at least includes the discovery ID list.

Step 1612: UE2 sends a discovery signal for D2D discovery in a broadcasting manner.

Step 1614: UE1 detects the discovery signal, and performs corresponding measurement on the detected discovery signal to obtain a measurement result of signal strength, signal quality and the like. Wherein, UE1 may perform D2D measurement on the adjacent D2D UE in an RRC idle state or an RRC connected state.

Step 1616: UE1 judges whether a measurement reporting condition is met or not according to a D2D measurement configuration signal configured by the Node B, and reports the D2D measurement result to the Node B through a D2D measurement report after the corresponding condition is met. The measurement reporting condition includes the following three types: event-based triggering, periodic triggering and event-based periodic triggering, specifically as follows:

1) when the measurement reporting condition configured for the UE by the Node B is event-based triggering, measurement reporting condition information includes threshold information corresponding to an event rule which triggers reporting of the D2D measurement result, and the UE determines whether to trigger the reporting of the D2D measurement result or not according to the predefined event rule after comparing the D2D measurement result with a received threshold.

2) when the measurement reporting condition configured for the UE by the Node B is periodic triggering, the measurement reporting condition information at least includes period information of triggering the reporting of the D2D measurement result, and the UE periodically triggers the reporting of the D2D measurement result according to the period information.

3) when the measurement reporting condition configured for the UE by the Node B is event-based periodic triggering, the measurement reporting condition information includes the threshold information corresponding to an event which triggers the reporting of the D2D measurement result and the period information of triggering the reporting of the D2D measurement result, and the UE triggers the reporting of the D2D measurement result according to the threshold and the period information.

The measurement report may include the following contents:

1) a discovery ID of the measured UE;

2) a resource used by the discovery signal received by the UE;

3) the signal strength of the discovery signal received by the UE;

4) the signal quality of the discovery signal received by the UE, such as SNR;

5) indication information indicating whether the UE is currently performing cellular communication with the UE sending the received discovery signal or not;

6) indication information about whether the UE tends to adopt D2D communication or not; and

7) D2D capability information of the UE.

The Node B may perform subsequent operation according to the measurement report of the UE after receiving the measurement report. For example, when the measurement report of UE1 includes information such as identification information of UE2, a discovery signal resource used by UE2 and signal quality/strength, the Node B subsequently sends the information of UE2 to the MME to perform network side verification to determine whether UE1 and UE2 may perform D2D mutual discovery or not.

### METHOD EMBODIMENT 4

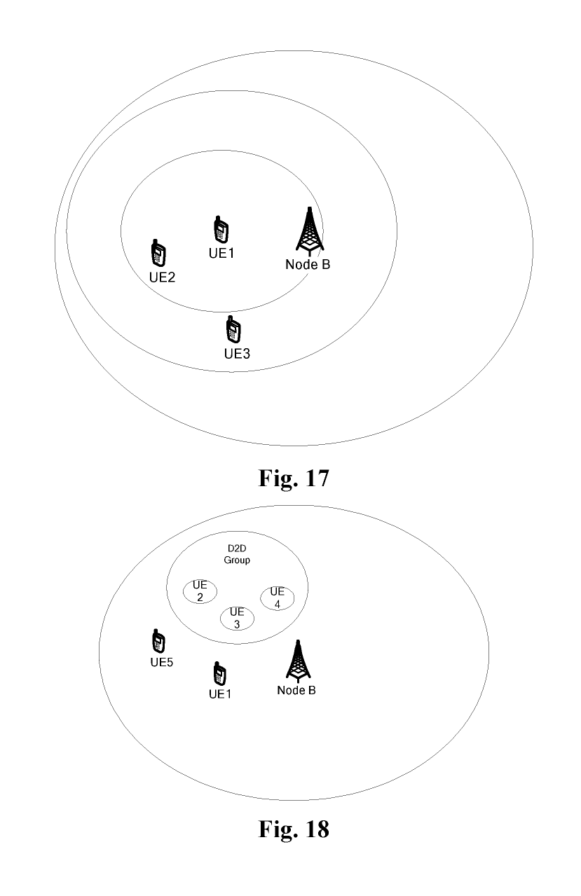

The embodiment describes a method for measurement and reporting under the condition that a to-be-measured object configured to UE by a Node B is a range. FIG. 17 is a scenario diagram of an example method embodiment 4 of the disclosure, and as shown in FIG. 17, UE1, UE2 and UE3 are in a cell of the same Node B. In the embodiment, measurement object information configured for UE1 by the Node B indicates a to-be-measured range of UE1, and then UE1 is only required to detect or measure discovery signals within the range indicated in the measurement object information. Wherein, the to-be-measured range configured for the UE1 by the Node B may be a geographical location range, or a signal strength range, or a signal quality range, or the like. Wherein, UE1 may perform D2D measurement on adjacent D2D UE in an RRC idle state or an RRC connected state.

When the to-be-measured range configured to UE1 by the Node B is a geographical location range, UE1 measures a D2D discovery signal of the adjacent UE according to its own geographical location information and geographical location information of the adjacent UE. For example, it is configured by the Node B that UE1 is only required to measure a discovery signal of UE within 200 meters, and when UE2 is at a distance of less than 200 meters far away from UE1, UE1 is required to perform D2D measurement on UE2; and when the distance between UE3 and UE1 is more than 200 meters, UE1 does not perform D2D measurement on UE3. UE1 may determine the geographical location of its own geographical location and a geographical location of the adjacent UE according to a locating method.

When the to-be-measured range configured for UE1 by the Node B is a signal strength range, UE1 measures the D2D discovery signal of the adjacent UE according to signal strength of the adjacent UE. For example, it is configured by the Node B that UE1 is only required to measure a discovery signal of which signal strength is more than a certain specific threshold, and when the signal strength of the discovery signal, received by UE1, of UE2 is more than or equal to the specific threshold, UE1 is required to perform D2D measurement on UE2; and when the signal strength of a discovery signal, received by UE1, of UE3 is less than the specific threshold, UE1 does not perform D2D measurement on UE3.

When the to-be-measured range configured for UE1 by the Node B is a signal quality range, UE1 measures the D2D discovery signal of the adjacent UE according to the signal quality of the adjacent UE. For example, it is configured by the Node B that UE1 is only required to measure a discovery signal of which signal quality is higher than a certain specific threshold, and when the signal quality of the discovery signal, received by UE1, of UE2 is more than or equal to the specific threshold, UE1 is required to perform D2D measurement on UE2; and when the signal quality of the discovery signal, received by UE1, of UE3 is lower than the specific threshold, UE1 does not perform D2D measurement on UE3.

Optionally, the Node B may configure the to-be-measured range for the UE according to a power-saving requirement and/or QoS requirement of the UE. The Node B may acquire the power-saving requirement and/or QoS requirement of the UE in manners as follows.

1) The UE directly sends the power-saving requirement and/or the QoS requirement to the Node B.

2) The UE sends the power-saving requirement and/or the QoS requirement to the D2D server at first, and then the D2D server indicates the power-saving requirement and/or QoS requirement of the UE to the Node B; or the D2D server indicates the QoS requirement to the Node B according to related information of an application program.

3) The Node B acquires the power-saving requirement and/or QoS requirement of the UE according to context information, stored by itself, of the UE; and for example, the Node B may acquire the power-saving requirement of the UE according to Discontinuous Reception (DRX) information and acquire the QoS requirement of the UE in the application program according to the related information of the application program.

UE1 triggers and reports a measurement report according to a measurement reporting condition and measurement reporting content information in D2D measurement configuration information after executing D2D measurement on the adjacent UE, and detailed description about the triggering and reporting of the measurement report refers to Step 1406 and Step 1408 in example method embodiment 1.

### METHOD EMBODIMENT 5

The embodiment describes a method for measurement and reporting under the condition that a to-be-measured object configured for a UE by a Node B is a D2D group. FIG. 18 is a scenario diagram of an example method embodiment 5 of the disclosure, and as shown in FIG. 18, UE1, UE2, UE3, UE4 and UE5 are located in a cell of the same Node B, and are adjacent to one another. Wherein, UE2, UE3 and UE5 are in the same D2D group. In the embodiment, measurement object information configured for UE1 by the Node B indicates to-be-measured D2D group identification information (such as a group ID, or a discovery signal resource set used for the D2D group), and then UE1 is only required to detect or measure discovery signals of the UE in the D2D group identified by the group ID or in the discovery signal resource set. Wherein, the group ID is carried in the D2D discovery signals. Optionally, the group ID may be included in a discovery ID.

UE1 detects the discovery signal of UE5 in a process of performing D2D measurement on the basis of D2D measurement configuration information configured by the Node B, and however, UE1 neglects UE5 because UE5 does not belong to the to-be-measured D2D group configured for UE1 by the Node B. UE1 also detects the D2D discovery signals of UE2, UE3 and UE4, and UE1 performs corresponding D2D measurement and reporting on UE2, UE3 and UE4 because UE2, UE3 and UE4 belong to the to-be-measured D2D group configured for UE1 by the Node B. Wherein, UE1 may perform D2D measurement on the adjacent D2D UE in an RRC idle state or an RRC connected state. UE1 triggers and reports a measurement report according to a measurement reporting condition and measurement reporting content information in the D2D measurement configuration information, and detailed description about the triggering and reporting of the measurement report refers to Step 1406 and Step 1408 in example method embodiment 1.

### METHOD EMBODIMENT 6

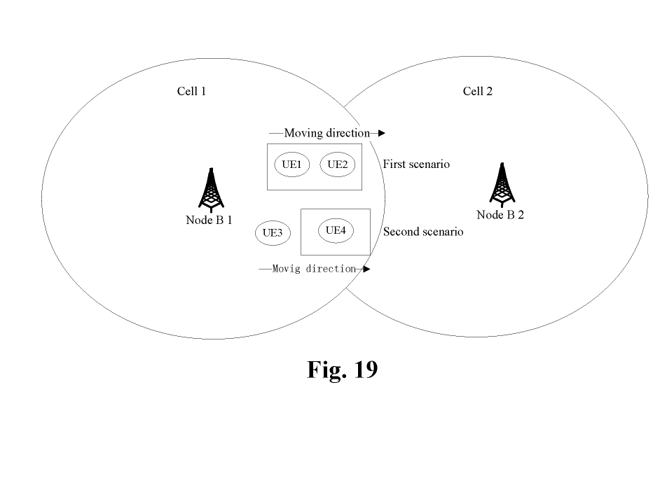

The embodiment describes a method for measurement and reporting under the condition that UE reports a related D2D content when performing cellular system measurement reporting. FIG. 19 is a scenario diagram of an example method embodiment 6 of the disclosure, and as shown in FIG. 19, cell 1 and cell 2 are adjacent cells, and UE1, UE2, UE3 and UE4 are all served by cell 1, and are all located on an edge of cell 1. Wherein, in a first scenario, UE1 and UE2 are located in vehicle 1, and simultaneously move towards cell 2, and UE1 and UE2 currently perform D2D communication. In a second scenario, UE3 is still, and UE4 is in vehicle 2, and moves towards cell 2. UE3 and UE4 currently perform D2D communication.

In the embodiment, the UE reports the related D2D content when performing cellular system measurement reporting, and there may exist conditions as follows: the UE triggers a D2D measurement report at the same time when triggering cellular system measurement reporting, or the UE contains a D2D measurement reporting content in a cellular system measurement report. Optionally, the D2D measurement report (content) includes a D2D discovery ID and D2D channel measurement result of the opposite D2D UE. Such a measurement reporting manner is beneficial for a cellular network to take channel conditions in two communication modes into comprehensive consideration so as to better perform Radio Resource Management (RRM) and improve quality of user service. For example, when one end UE currently performing D2D communication is about to perform cell handover, the network may determine whether D2D communication between the UE and the opposite UE can be continued or not, and when D2D communication cannot be continued, the network may convert the D2D communication mode between the UEs into the cellular communication mode as early as possible. Specifically, in the first scenario of the embodiment, UE1 or UE2 triggers cellular system measurement reporting, and simultaneously sends the D2D discovery ID and D2D channel measurement result of the opposite UE to the Node B, and the Node B judges whether the D2D channel measurement result between UE1 and UE2 is consistent with a D2D communication continuing condition or not, then may further judge whether UE1 and UE2 can be handed over to the same target cell or not, and the above two judgment results are yes, UE1 and UE2 are hand over to the same cell for continuous D2D communication. In the second scenario of the embodiment, UE3 or UE4 triggers cellular system measurement reporting, and simultaneously sends the D2D discovery ID and D2D channel measurement result of the opposite UE to the Node B, and the Node B may switch D2D communication between UE3 and UE4 into the cellular communication mode when determining that the D2D channel measurement result between UE3 and UE4 is inconsistent with the D2D communication continuing condition.

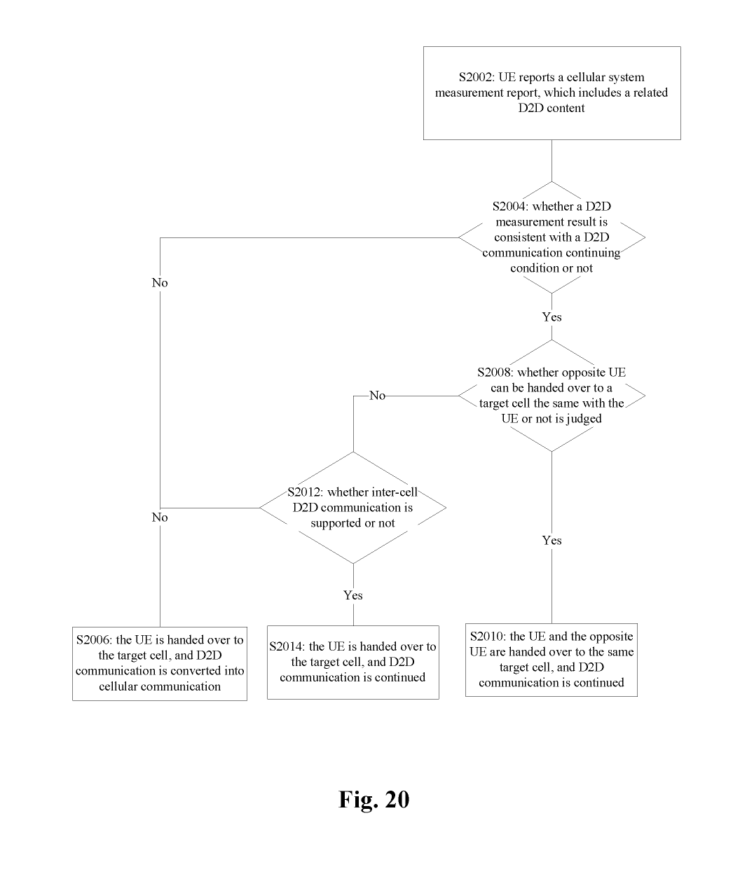

FIG. 20 is a flowchart of an example method embodiment 6 of the disclosure, and as shown in FIG. 20, the flow includes the following steps:

Step 2002: the UE reports a cellular system measurement report, and simultaneously triggers the D2D measurement report or contains the D2D measurement reporting content in the cellular system measurement report according to the D2D measurement configuration configured by the Node B. That is, the D2D measurement reporting content may be included in a cellular system measurement report message, and may also be contained in an independent RRC message. Wherein, the D2D measurement reporting content at least includes identification information (for example, the D2D discovery ID, or the resource for a D2D signal) and D2D channel measurement result of the opposite UE. Wherein the D2D signal refers to a signal for a D2D discovery or D2D communication process, and includes, but not limited to: a discovery signal, a reference signal, a synchronization signal, a pilot frequency signal and a preamble signal. Wherein the D2D channel measurement result may be signal strength and/or signal quality of the D2D signal received by the UE.

Step 2004: the Node B judges whether the D2D measurement result is consistent with the D2D communication continuing condition or not after receiving the measurement report.

Step 2006: when the D2D measurement result is inconsistent with the D2D communication continuing condition, the Node B converts D2D communication between the UE and the opposite UE into the cellular communication mode.

Step 2008: when the D2D measurement result is consistent with the D2D communication continuing condition, the Node B further judges whether the opposite UE currently performing D2D communication with the UE can be handed over to the target cell the same with the UE or not. Optionally, the Node B may configure for the opposite UE on which cellular system RRM measurement is performed and makes a judgment according to the measurement report of the opposite UE.

Step 2010: when the opposite UE can be handed over to the target cell the same with the UE, the Node B hands over the UE and the opposite UE to the same cell, and the UE continues performing D2D communication with the opposite UE in the new cell.

Step 2012: when the opposite UE cannot be handed over to the target cell the same with the UE, the Node B further judges whether the cell where the opposite UE is located and the target cell of the UE support inter-cell D2D communication or not. The Node B may acquire whether adjacent Node Bs support inter-cell D2D communication or not by virtue of Operation Administration and Maintenance (OAM) configuration or inter-Node B interaction.

Step 2014: when the cell where the opposite UE is located and the target cell of the UE support inter-cell D2D communication, the Node B hands over the UE to the target cell, and the UE and the opposite UE are located in different cells respectively, and continue performing D2D communication. when the cell where the opposite UE is located or the target cell of the UE does not support inter-cell D2D communication, the Node B converts D2D communication between the UE into cellular communication, and hands over the UE to the target cell.

### METHOD EMBODIMENT 7

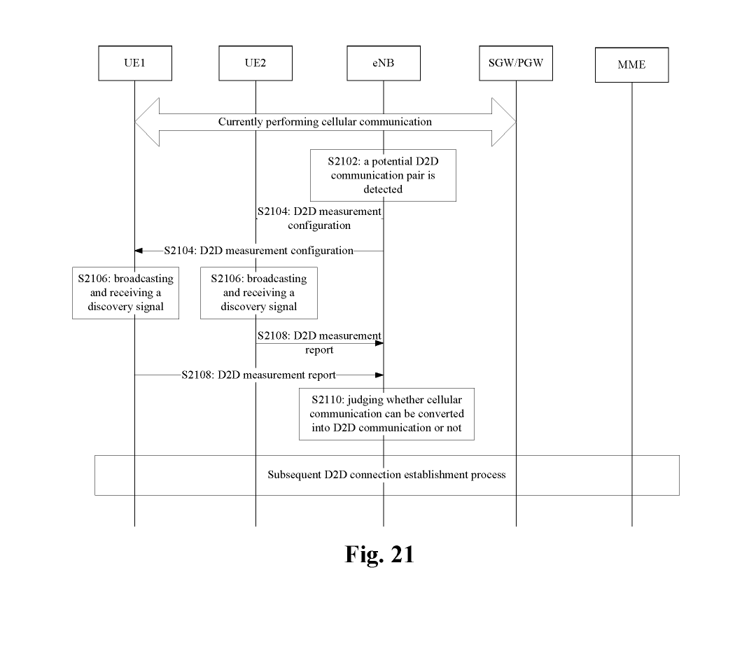

The embodiment describes a method for measurement and reporting under the condition that a Node B configures D2D measurement configuration information to UE for a specific object. FIG. 21 is a flowchart of an example method embodiment 7 of the disclosure, and as shown in FIG. 21, the flow includes the following steps. Wherein, UE1 and UE2 currently perform cellular communication.

Step 2102: a network side network element of a cellular network detects a potential D2D communication pair currently performing cellular communication. Optionally, the potential D2D communication pair may be detected on the basis of a burden reduction requirement of the cellular network. Optionally, the network side network element may judges whether the communication pair is located in the same cell or not according to source and target IP addresses or General Packet Radio Service Tunnel Protocol (GTP) Tunnel Endpoint Identifiers (TEIDs) of UE data packets. Wherein, the network side network element of the cellular network may be a Node B or a Serving GateWay/Packet Data Network GateWay (SGW/PGW).

Step 2104: when the Node B judges the potential D2D communication pair, the Node B performs D2D measurement configuration on both pieces of UE of the potential D2D communication pair; and when the SGW/PGW judges the potential D2D communication pair, the SGW/PGW sends related information of the potential D2D communication pair to the Node B, and then the Node B performs D2D measurement configuration on both pieces of UE of the potential D2D communication pair. The Node B configures corresponding D2D measurement on the opposite UE for the potential D2D communication pair UE1 and UE2. Measurement object information in D2D configuration information sent to UE1 and UE2 of the potential D2D communication pair by the Node B is identification information (for example, a D2D discovery ID) of the opposite UE or a resource (time-domain and/or frequency-domain and/or code-domain) used for a D2D discovery signal. Optionally, the Node B further allocates the D2D discovery signal resources to UE1 and UE2, and indicates UE1 and UE2 to send the D2D discovery signals. Optionally, the Node B may further allocate resources for sending D2D signals for measurement to UE1 and UE2. Optionally, the Node B may indicate the resources, allocated to the opposite UE by itself, to UE1 and UE2. Wherein, the D2D signal refers to a signal for D2D a discovery or D2D communication process, and includes, but not limited to: a discovery signal, a reference signal, a synchronization signal, a pilot frequency signal, a preamble signal and the like.

Step 2106: UE1 and UE2 send the D2D signals, and detect and measure the D2D signals of the opposite UE according to the measurement configuration information configured by the Node B.

Step 2108: UE1 and UE2 trigger and report measurement reports according to measurement reporting conditions and measurement reporting content information in the D2D measurement configuration information. The measurement reports may include the following contents:

1) identification information related to the opposite UE (such as a discovery ID and identification information of a user using the opposite UE);

2) the D2D signal resources used by the opposite UE;

3) signal strength of the discovery signals received by the UE;

4) signal quality of the discovery signals received by the UE, such as SNR;

5) indication information indicating whether the UE tends to adopt D2D communication or not; and

6) D2D capability information of the UE.

Step 2110: after receiving the D2D measurement reports of UE1 and UE2, the Node B judges whether cellular communication between UE1 and UE2 can be converted into D2D communication or not according to at least one of the following information in the measurement reports: D2D channel measurement results, D2D capabilities, indication information about whether the UE tends to adopt D2D communication or not. When it is determined that cellular communication can be converted into D2D communication, the Node B performs a subsequent D2D connection establishment process, for example, allocating D2D communication resources to the UE.

Obviously, those skilled in the art should know that each component or step of the disclosure may be implemented by a universal computing device, and the components or steps may be concentrated on a single computing device or distributed on a network formed by multiple computing devices, and may optionally be implemented by programmable codes executable for the computing devices, so that the components or steps may be stored in a storage device for execution with the computing devices, or may form each integrated circuit component, or multiple components or steps therein may form a single integrated circuit component for implementation. As a consequence, the disclosure is not limited to any specific hardware and software combination.

The above is only the preferred embodiment of the disclosure and not intended to limit the disclosure, and for those skilled in the art, the disclosure may have various modifications and variations. Any modifications, equivalent replacements, improvements and the like within the spirit and principle of the disclosure shall fall within the scope of protection of the disclosure.

### INDUSTRIAL APPLICABILITY

From the above, the method and device for processing the D2D measurement provided by the embodiment of the disclosure have beneficial effects as follows: the problem of incapability in effectively controlling D2D discovery and D2D communication in the related art is solved, and effects of effectively controlling D2D discovery and D2D communication, increasing a resource utilization rate and improving quality of user service are further achieved.

1. A method for processing a Device-to-Device (D2D) measurement, comprising:
receiving D2D measurement configuration information issued by a network node, wherein the D2D measurement configuration information is User Equipment (UE)-based D2D measurement configuration information;
performing a UE-based D2D measurement according to the D2D measurement configuration information; and
reporting, according to the D2D measurement configuration information, a D2D measurement result obtained by the UE-based D2D measurement.

2. The method as claimed in claim 1, wherein the D2D measurement configuration information comprises at least one of:
UE-based measurement object information, a UE-based measurement reporting condition and a UE-based measurement reporting content.

3. The method as claimed in claim 1, wherein performing the UE-based D2D measurement according to the D2D measurement configuration information comprises at least one of:
performing, by a UE in a Radio Resource Control (RRC) idle state, the UE-based D2D measurement according to the D2D measurement configuration information which is obtained by the UE when the UE is in an RRC idle state;
performing, by a UE in an RRC idle state, the UE-based D2D measurement according to the D2D measurement configuration information which is obtained by the UE when the UE is in an RRC connected state;
performing, by a UE in an RRC connected state, the UE-based D2D measurement according to the D2D measurement configuration information which is obtained by the UE when the UE is in an RRC idle state; and
performing, by a UE in an RRC connected state, the UE-based D2D measurement according to the D2D measurement configuration information which is obtained by the UE when the UE is in an RRC connected state; when the UE-based measurement object information comprised in the D2D measurement configuration information comprises an indicated resource, which comprises at least one of: a time-domain resource, a frequency-domain resource and a code-domain resource, performing a D2D measurement on a UE using the indicated resource;
when the UE-based measurement object information in the D2D measurement configuration information comprises identification information used for indicating a measurement object, performing a D2D measurement on a UE identified by the identification information or a UE used by a user identified by the identification information;
when the UE-based measurement object information comprised in the D2D measurement configuration information comprises a indicated measurement range, performing a D2D measurement on a UE within the indicated measurement range; and
when the UE-based measurement object information comprised in the D2D measurement configuration information comprises an indicated measurement D2D group, performing a D2D measurement on a UE in the indicated measurement D2D group.

4. (canceled)

5. The method as claimed in claim 43, wherein performing the UE-based D2D measurement according to the D2D measurement configuration information comprises:
performing the D2D measurement on the UE by measuring a D2D signal sent by the UE, wherein the D2D signal comprises at least one of: a discovery signal, a reference signal, a synchronization signal, a pilot frequency signal and a preamble signal.

6. (canceled)

7. The method as claimed in claim 43, wherein
the identification information comprises at least one of:
UE identification information of a friend in an application program of the UE, user identification information of a friend in the application program of the UE, UE identification information of a UE currently performing cellular network communication with the UE and user identification information of a user currently performing cellular network communication with the UE; or
the indicated measurement range comprises at least one of: a geographical location range, a signal strength range and a signal quality range.

8. (canceled)

9. The method as claimed in claim 2, wherein reporting, according to the UE-based measurement reporting condition, the D2D measurement result obtained by the UE-based D2D measurement comprises at least one of:
when the UE-based measurement reporting condition comprised in the D2D measurement configuration information is a event-based triggering condition, judging whether the D2D measurement result meets a reporting triggering threshold condition comprised in the UE-based measurement reporting condition or not, and when a judgment result is that the D2D measurement result meets the reporting triggering threshold condition comprised in the UE-based measurement reporting condition, reporting the D2D measurement result;
when the UE-based measurement reporting condition comprised in the D2D measurement configuration information is a periodic triggering condition, reporting the D2D measurement result according to a period indicated in the UE-based measurement reporting condition;
when the UE-based measurement reporting condition comprised in the D2D measurement configuration information is a event-based periodic triggering condition, reporting the D2D measurement result according to a threshold value condition and a period comprised in the UE-based measurement reporting condition; and
when the UE-based measurement reporting condition comprised in the D2D measurement configuration information is a condition of reporting the D2D measurement result at the same time of sending a cellular system measurement report, reporting the D2D measurement result at the same time when the cellular system measurement report is sent.

10. The method as claimed in claim 9, wherein reporting the D2D measurement result at the same time when the cellular system measurement report is sent comprises at least one of:
triggering reporting of the D2D measurement result at the same time when the cellular system measurement report is triggered; and
containing the D2D measurement result in the cellular system measurement report.

11. The method as claimed in claim 2, wherein the D2D measurement result reported according to the UE-based measurement reporting content comprises at least one of:
identification information of a UE sending a D2D signal received by a current UE, wherein the identification information of the UE sending the D2D signal received by the current UE comprises at least one of: UE identification information for identifying the UE sending the D2D signal; user identification information for identifying a user using the UE sending the D2D signal; D2D group identification information for identifying a D2D group to which the UE sending the D2D signal belongs; and D2D group identification information for identifying a D2D group to which the user of the UE sending the D2D signal belongs;
a D2D signal resource used by a D2D signal received by a current UE;
signal strength of a D2D signal received by a current UE;
signal quality of a D2D signal received by a current UE;
indication information indicating whether a current UE is currently performing cellular communication with a UE sending a D2D signal received by the current UE or not;
identification information of a UE currently performing D2D communication with a current UE;
indication information about whether a current UE tends to adopt D2D communication or not; and
D2D capability information of a current UE.

12. (canceled)

13. The method as claimed in claim 1, after receiving the D2D measurement configuration information issued by the network node, wherein the D2D measurement configuration information is UE-based D2D measurement configuration information, further comprising:
when a residing cell is replaced, deleting a measurement configuration indicated by the D2D measurement configuration information received, by a UE in an RRC idle state, in an original residing cell; or,
when deletion indication information carried in the D2D measurement configuration information issued by the network node is received, deleting a measurement configuration corresponding to the deletion indication information, wherein the deletion indication information is received by a UE in an RRC connected state.

14. A method for processing a Device-to-Device (D2D) measurement, comprising:
sending D2D measurement configuration information to a User Equipment (UE), wherein the D2D measurement configuration information is UE-based D2D measurement configuration information; and
receiving a D2D measurement result reported by the UE according to the D2D measurement configuration information, wherein the UE performs a UE-based D2D measurement according to the D2D measurement configuration information.

15. The method as claimed in claim 14, wherein
the D2D measurement configuration information comprises at least one of: UE-based measurement object information, a UE-based measurement reporting condition and a UE-based measurement reporting content; or
the D2D measurement configuration information is sent to the UE in a system broadcasting manner and/or in a dedicated signalling manner.

16. The method as claimed in claim 14, before sending the D2D measurement configuration information to the UE, wherein the D2D measurement configuration information is UE-based D2D measurement configuration information, further comprising at least one of:
determining location information of the UE in a cell; and
configuring the D2D measurement configuration information for the UE according to the location information of the UE in the cell;
configuring the D2D measurement configuration information for the UE according to information received from a D2D server;
configuring the D2D measurement configuration information for the UE according to a network burden reduction requirement;
configuring the D2D measurement configuration information for the UE according to a power-saving requirement of the UE; and
configuring the D2D measurement configuration information for the UE according to a Quality of Service (QoS) requirement of the UE.

17. (canceled)

18. (canceled)

19. The method as claimed in claim 15, wherein sending the D2D measurement configuration information to the UE in the system broadcasting manner comprises:
broadcasting at least one of the following information in the system broadcasting manner: a time-domain resource available for the UE in a cell of a network node, a frequency-domain resource available for the UE in the cell of the network node, a code-domain resource available for the UE in the cell of the network node and identification information available for the UE in the cell of the network node.

20. The method as claimed in claim 14, after receiving the D2D measurement result reported by the UE according to the D2D measurement configuration information, further comprising at least one of:
performing a D2D discovery operation according to the D2D measurement result;
performing a D2D communication operation according to the D2D measurement result;
judging whether to initiate a D2D connection establishment process for the UE or not according to the D2D measurement result, and when a judgement result is to initiate the D2D connection establishment process for the UE, initiating the D2D connection establishment process;
judging whether to convert a communication manner of the UE from cellular communication into D2D communication or not according to the D2D measurement result, and when a judgement result is to convert the communication manner of the UE from the cellular communication into the D2D communication, converting the communication manner of the UE from the cellular communication into the D2D communication; and
judging whether to convert the communication manner of the UE from the D2D communication into the cellular communication or not according to the D2D measurement result, and when a judgment result is to convert the communication manner of the UE from the D2D communication into the cellular communication, converting the communication manner of the UE from the D2D communication into the cellular communication.

21. A device for processing a Device-to-Device (D2D) measurement, comprising:
a first receiving component, configured to receive D2D measurement configuration information issued by a network node, wherein the D2D measurement configuration information is based on a User Equipment (UE);
a first measuring component, configured to perform a UE-based D2D measurement according to the D2D measurement configuration information; and
a first reporting component, configured to report, according to the D2D measurement configuration information, a D2D measurement result obtained by the UE-based D2D measurement.

22. The device as claimed in claim 21, wherein the first measuring component comprises at least one of:
a first measuring element, configured for a UE in a Radio Resource Control (RRC) idle state to perform the UE-based D2D measurement according to the D2D measurement configuration information which is obtained by the UE when the UE is in an RRC idle state;
a second measuring element, configured for the UE in an RRC idle state to perform the UE-based D2D measurement according to the D2D measurement configuration information which is obtained by the UE when the UE is in an RRC connected state;
a third measuring element, configured for the UE in an RRC connected state to perform the UE-based D2D measurement according to the D2D measurement configuration information which is obtained by the UE when the UE is in an RRC idle state; and
a fourth measuring element, configured for the UE in an RRC connected state to perform the UE-based D2D measurement according to the D2D measurement configuration information which is obtained by the UE when the UE is in an RRC connected state;
a fifth measuring element, configured to, when the UE-based measurement object information comprised in the D2D measurement configuration information comprises an indicated resource, which comprises at least one of: a time-domain resource, a frequency-domain resource and a code-domain resource, perform a D2D measurement on a UE using the indicated resource;
a sixth measuring element, configured to, when the UE-based measurement object information comprised in the D2D measurement configuration information comprises identification information used for identifying a measurement object, perform a D2D measurement on a UE identified by the identification information or a UE used by a user identified by the identification information;
a seventh measuring element, configured to, when the UE-based measurement object information comprised in the D2D measurement configuration information comprises a indicated measurement range, perform a D2D measurement on a UE within the indicated measurement range; and
an eighth measuring element, configured to, when the UE-based measurement object information comprised in the D2D measurement configuration information comprises an indicated measurement D2D group, perform a D2D measurement on a UE in the indicated measurement D2D group.

23. (canceled)

24. The device according to claim 22, wherein
the first measuring component is further configured to perform a D2D measurement on the UE by measuring a D2D signal sent by the UE.

25. The device as claimed in claim 21, wherein the first reporting component comprises at least one of:
a first reporting element, configured to, when the UE-based measurement reporting condition comprised in the D2D measurement configuration information is a event-based triggering condition, judge whether the D2D measurement result meets a reporting triggering threshold condition comprised in the UE-based measurement reporting condition or not, and when a judgment result is that the D2D measurement result meets the reporting triggering threshold condition comprised in the UE-based measurement reporting condition, report the D2D measurement result;
a second reporting element, configured to, when the UE-based measurement reporting condition comprised in the D2D measurement configuration information is a periodic triggering condition, report the D2D measurement result according to a period indicated in the UE-based measurement reporting condition;
a third reporting element, configured to, when the UE-based measurement reporting condition comprised in the D2D measurement configuration information is a event-based periodic triggering condition, report the D2D measurement result according to a threshold value condition and a period comprised in the UE-based measurement reporting condition; and
a fourth reporting element, configured to, when the UE-based measurement reporting condition comprised in the D2D measurement configuration information is a condition of reporting the D2D measurement result at the same time of sending a cellular system measurement report, report the D2D measurement result at the same time when the cellular system measurement report is given.

26. The device as claimed in claim 21, wherein the device further comprises:
a first deleting component, configured to, when a residing cell is replaced, delete a measurement configuration indicated by the D2D measurement configuration information received, by a UE in an RRC idle state, in an original residing cell; or,
a second deleting component, configured to, when deletion indication information carried in the D2D measurement configuration information issued by the network node is received, delete a measurement configuration corresponding to the deletion indication information, wherein the deletion indication information is received by a UE in an RRC connected state.

27. A device for processing a Device-to-Device (D2D) measurement, comprising:
a first sending component, configured to send D2D measurement configuration information to a User Equipment (UE), wherein the D2D measurement configuration information is based on the UE; and
a second receiving component, configured to receive a D2D measurement result reported by the UE according to the D2D measurement configuration information, wherein the UE performs a UE-based D2D measurement according to the D2D measurement configuration information.

28. The device as claimed in claim 27, the device further comprises at least one of:
a first determining component, configured to determine location information of the UE in a cell; and
a first configuring component, configured to configure the D2D measurement configuration information for the UE according to the location information of the UE in the cell;
a second configuring component, configured to configure the D2D measurement configuration information for the UE according to information received from a D2D server;
a third configuring component, configured to configure the D2D measurement configuration information to the UE according to a network burden reduction requirement;
a fourth configuring component, configured to configure the D2D measurement configuration information for the UE according to a power-saving requirement of the UE; and
a fifth configuring component, configured to configure the D2D measurement configuration information for the UE according to a Quality of Service (QoS) requirement of the UE.

29. (canceled)

30. The device as claimed in claim 27, the device further comprises at least one of:
a first performing component, configured to perform a D2D discovery operation according to the D2D measurement result;
a second performing component, configured to perform a D2D communication operation according to the D2D measurement result;
a first judging component, configured to judge whether to initiate a D2D connection establishment process for the UE or not according to the D2D measurement result, and when a judgement result is to initiate the D2D connection establishment process for the UE, initiate the D2D connection establishment process;
a second judging component, configured to judge whether to convert a communication manner of the UE from cellular communication into D2D communication or not according to the D2D measurement result, and when a judgement result is to convert the communication manner of the UE from the cellular communication into the D2D communication, convert the communication manner of the UE from the cellular communication into the D2D communication; and
a third judging component, configured to judge whether to convert the communication manner of the UE from the D2D communication into the cellular communication or not according to the D2D measurement result, and when a judgment result is to convert the communication manner of the UE from the D2D communication into the cellular communication, convert the communication manner of the UE from the D2D communication into the cellular communication.
